(19) United States
(12) Patent Application Publication
(10) Pub. No.: US 2024/0058750 A1
(43) Pub. Date: Feb. 22, 2024

(54) IMPROVING CATALYTIC EFFICIENCY OF FLUE GAS FILTRATION THROUGH SALT FORMATION BY USING AT LEAST ONE OXIDIZING AGENT

(71) Applicant: W. L. Gore & Associates, Inc., Newark, DE (US)

(72) Inventors: Zhuonan Song, Elkton, MD (US); Stephen Stark, Wilmington, DE (US)

(21) Appl. No.: 18/270,100

(22) PCT Filed: Dec. 23, 2021
(86) PCT No.: PCT/US2021/065068

§ 371 Date: Jun. 28, 2023

Related U.S. Application Data
(60) Provisional application No. 63/132,289, filed on Dec. 30, 2020.

(51) Int. Cl. B01D 53/50; B01D 53/86; B01D 53/79; B01D 53/56; B01D 53/76; F23J 15/00; F23J 15/02

(52) U.S. Cl. CPC B01D 53/507; B01D 53/8609; B01D 53/8625; B01D 53/79; B01D 53/56; B01D 53/76; F23J 15/003; F23J 15/025; B01D 2251/2062; B01D 2258/0291; B01D 2251/106; B01D 2257/404; F23J 2215/20; F23J 2219/10; F23J 2217/101; F23J 2215/10

(57) ABSTRACT

Systems and methods for increasing removal efficiency of at least one filter medium. In some embodiments, at least one oxidizing agent is introduced into the flue gas stream, so as to react SO2 with the at least one oxidizing agent to form sulfur trioxide (SO3), sulfuric acid (H2SO4), or any combination thereof. Some of the embodiments further include introducing ammonia (NH3) and or dry sorbent into the flue gas stream, so as to react at least some of the sulfur trioxide (SO3), at least some of the sulfuric acid (H2SO4), or any combination thereof, with the ammonia (NH3) and form at least one salt.

### CROSS-REFERENCE TO RELATED APPLICATIONS

The present application is a national phase application of PCT Application No. PCT/US2021/065068, internationally filed on Dec. 23, 2021, and entitled “IMPROVING CATALYTIC EFFICIENCY OF FLUE GAS FILTRATION THROUGH SALT FORMATION BY USING AT LEAST ONE OXIDIZING AGENT,” which claims priority to and claims the benefit of U.S. Provisional Patent Application No. 63/132,289, filed Dec. 30, 2020, and entitled “IMPROVING CATALYTIC EFFICIENCY OF FLUE GAS FILTRATION THROUGH SALT FORMATION BY USING AT LEAST ONE OXIDIZING AGENT,” the entireties of which are herein incorporated by reference.

### FIELD

The present disclosure relates to the field of a filter medium, and methods and systems for using the same to filter a flue gas stream.

### BACKGROUND

Coal-fired power generation plants, municipal waste incinerators, and oil refinery plants generate large amounts of flue gases that contain substantial varieties and quantities of environmental pollutants, nitrogen oxides (NOx compounds), mercury (Hg) vapor, sulfur oxides and particulate matters (PM). In the United States, burning coal alone generates about 27 million tons of SO₂ and 45 tons of Hg each year. Thus, there is a need for improvements to methods for removing NOx compounds, sulfur oxides (SO₂), mercury vapor, and fine particulate matters from industrial flue gases, such as coal-fired power plant flue gas.

### SUMMARY

In some embodiments, a method comprises obtaining at least one filter medium; wherein the at least one filter medium comprises at least one catalyst material; flowing a flue gas stream transverse to a cross section of the at least one filter medium, such that the flue gas stream passes through the cross section of the at least one filter medium, wherein the flue gas stream comprises sulfur dioxide (SO₂); and increasing a SO₂ removal efficiency of the at least one filter medium, wherein increasing the SO₂ removal efficiency of the at least one filter medium comprises introducing at least one oxidizing agent into the flue gas stream, so as to react at least some of the SO₂ with the at least one oxidizing agent to form sulfur trioxide (SO₃), sulfuric acid (H₂SO₄), or any combination thereof; and introducing ammonia (NH₃) into the flue gas stream, so as to react at least some of the sulfur trioxide (SO₃), at least some of the sulfuric acid (H₂SO₄), or any combination thereof, with the ammonia (NH₃) and form at least one salt.

In some embodiments of the method, the SO₂ removal efficiency of the at least one filter medium is increased from 0.1% to 99.9% relative to an initial SO₂ removal efficiency of the at least one filter medium.

In some embodiments of the method, the flue gas stream further comprises NOx compounds comprising nitric oxide (NO); and nitrogen dioxide (NO₂), wherein introducing the at least one oxidizing agent into the flue gas stream increases a NO₂ concentration to a range from 2% to 99% of a total concentration of the NOx compounds, and wherein increasing the NO₂ concentration increases NOx removal efficiency of the at least one filter medium.

In some embodiments of the method, the at least one oxidizing agent comprises hydrogen peroxide (H₂O₂), ozone (O₃), hydroxyl radical, at least one organic peroxide, at least one metal peroxide, at least one peroxy-acid, at least one percarbonate salt, at least one perborate salt, at least one persulfate salt, at least one permanganate salt, at least one hypochlorite salt, chlorine dioxide (ClO₂), at least one chlorate salt, at least one perchlorate salt, at least one hypochlorite salt, perchloric acid (HClO₄), at least one bismuthate salt, any aqueous solution comprising at least one of the foregoing, or any combination thereof.

In some embodiments of the method, the at least one oxidizing agent is H₂O₂ or an aqueous solution thereof.

In some embodiments, the method further comprises introducing at least one dry sorbent into the flue gas stream so as to react at least some of the sulfur trioxide (SO₃), at least some of the sulfuric acid (H₂SO₄), or any combination thereof, with the at least one dry sorbent and form at least one salt.

In some embodiments of the method, the flue gas stream further comprises oxygen (O₂), water (H₂O), nitrogen (N₂), sulfur trioxide (SO₃), carbon monoxide (CO), at least one hydrocarbon, ammonia (NH₃), or any combination thereof.

In some embodiments of the method, the NH₃ is introduced into the flue gas stream in a concentration ranging from 0.0001% to 0.5% of the concentration of the flue gas stream.

In some embodiments of the method, the at least one oxidizing agent is introduced into the flue gas stream in a sufficient amount to convert at least 5% of the SO₂ in the flue gas stream, to SO₃, H₂SO₄, the at least one salt, or any combination thereof.

In some embodiments of the method, the sufficient amount of the at least one oxidizing agent that is introduced into the flue gas stream is 0.001 wt % to 90 wt % based on a total weight of the at least one oxidizing agent in water.

In some embodiments of the method, the sufficient amount of the at least one oxidizing agent that is introduced into the flue gas stream is 5 ppm to 10000 ppm of the flue gas stream.

In some embodiments of the method, the sufficient amount of the at least one oxidizing agent that is introduced into the flue gas stream is a concentration ratio of the at least one oxidizing agent to SO₂ of 1:10 to 20:1.

In some embodiments of the method, a temperature of the flue gas stream ranges from 100° C. to 300° C. at least during the flowing of the flue gas stream transverse to a cross section of the at least one filter medium.

In some embodiments of the method, the water is present the flue gas stream in an amount ranging from 0.1 vol % to 50 vol % based on a total volume of the flue gas stream at least during the flowing of the flue gas stream transverse to a cross section of the at least one filter medium.

In some embodiments of the method, the SO₂ is present in the flue gas stream in an amount from 0.01 ppm to 1000 ppm at least during the flowing of the flue gas stream transverse to a cross section of the at least one filter medium.

In some embodiments of the method, the NOx compounds are present in the flue gas stream in an amount from 0.1 ppm to 5000 ppm at least during the flowing of the flue gas stream transverse to a cross section of the at least one filter medium.

In some embodiments of the method, the at least one dry sorbent comprises sodium bicarbonate, trona, calcium hydroxide, calcium carbonate, calcium oxide, cement dust, lime, or any combination thereof.

In some embodiments, the method further comprises removing the at least one salt from the at least one filter medium.

In some embodiments of the method, the at least one filter medium comprises a porous protective layer; and a porous catalytic layer, wherein removing the at least one salt from the at least one filter medium comprises removing the at least one salt from the porous protective layer of the at least one filter medium.

In some embodiments of the method, the at least one salt comprises ammonium sulfate (AS) ammonium bisulfate (ABS), triammonium hydrogen disulfate (A₃HS₂), ammonium sulfamate (ASM), or any combination thereof.

In some embodiments of the method, introducing the NH₃ into the flue gas stream is performed after introducing the at least one oxidizing agent into the flue gas stream.

In some embodiments of the method, introducing the NH₃ into the flue gas stream is performed before introducing the at least one oxidizing agent into the flue gas stream, during the introducing of the at least one oxidizing agent into the flue gas stream, or any combination thereof.

In some embodiments of the method, introducing the at least one dry sorbent into the flue gas stream is performed after introducing the at least one oxidizing agent into the flue gas stream.

In some embodiments of the method, introducing the at least one dry sorbent into the flue gas stream is performed before introducing the at least one oxidizing agent into the flue gas stream, during the introducing of the at least one oxidizing agent into the flue gas stream, or any combination thereof.

In some embodiments, a method comprises obtaining at least one filter medium, wherein the at least one filter medium comprises at least one catalyst material; flowing a flue gas stream transverse to a cross section of the at least one filter medium, such that the flue gas stream passes through the cross section of the at least one filter medium, wherein the flue gas stream comprises sulfur dioxide (SO₂); and increasing a SO₂ removal efficiency of the at least one filter medium, wherein increasing the SO₂ removal efficiency of the at least one filter medium comprises introducing at least one oxidizing agent into the flue gas stream, so as to react at least some of the SO₂ with the at least one oxidizing agent to form sulfur trioxide (SO₃), sulfuric acid (H₂SO₄), or any combination thereof; and introducing at least one dry sorbent into the flue gas stream, so as to react at least some of the sulfur trioxide (SO₃), at least some of the sulfuric acid (H₂SO₄), or any combination thereof, with the at least one dry sorbent and form at least one salt.

In some embodiments, the method further comprises introducing ammonia (NH₃) into the flue gas stream, so as to react at least some of the sulfur trioxide (SO₃), at least some of the sulfuric acid (H₂SO₄), or any combination thereof, with the ammonia (NH₃) and form at least one salt.

In some embodiments of the method, increasing the SO₂ removal efficiency of the at least one filter medium comprises introducing at least one oxidizing agent into the flue gas stream, so as to react at least 1 ppm of the SO₂ with the at least one oxidizing agent to form sulfur trioxide (SO₃), sulfuric acid (H₂SO₄), or any combination thereof; and introducing ammonia (NH₃) into the flue gas stream, so as to react at least 1 ppm of the sulfur trioxide (SO₃), at least 1 ppm of the sulfuric acid (H₂SO₄), or any combination thereof, with the ammonia (NH₃) and form at least one salt.

In some embodiments of the method, ammonia (NH₃) is introduced into the flue gas stream in a concentration ratio of NH₃ to NOx compounds of 7:200 to 9:5.

In some embodiments, a system comprises at least one filter medium, wherein the at least one filter medium comprises an upstream side; a downstream side; at least one catalyst material; at least one filter bag, wherein the at least one filter medium is disposed within the at least one filter bag; and at least one filter bag housing, wherein the at least one filter bag is disposed within the at least one filter bag housing; wherein the at least one filter bag housing is configured to receive a flow of a flue gas stream transverse to a cross section of the at least one filter medium, such that the flue gas stream passes through the cross section of the at least one filter medium from the upstream side of the at least one filter medium to the downstream side of the at least one filter medium, wherein the flue gas stream comprises sulfur dioxide (SO₂), wherein the system is configured to increase a SOx removal efficiency of the at least one filter medium upon introduction of at least one oxidizing agent into the flue gas stream; and introduction of ammonia (NH₃) into the flue gas stream.

In some embodiments of the system, the system is configured to further increase a SOx removal efficiency of the at least one filter medium upon introduction of at least one dry sorbent into the flue gas stream.

In some embodiments, a system comprising at least one filter medium, wherein the at least one filter medium comprises an upstream side; a downstream side; at least one catalyst material; at least one filter bag, wherein the at least one filter medium is disposed within the at least one filter bag; and at least one filter bag housing, wherein the at least one filter bag is disposed within the at least one filter bag housing; wherein the at least one filter bag housing is configured to receive a flow of a flue gas stream transverse to a cross section of the at least one filter medium, such that the flue gas stream passes through the cross section of the at least one filter medium from the upstream side of the at least one filter medium to the downstream side of the at least one filter medium, wherein the flue gas stream comprises sulfur dioxide (SO₂), wherein the system is configured to increase a SOx removal efficiency of the at least one filter medium upon introduction of at least one oxidizing agent into the flue gas stream; and introduction of at least one dry sorbent into the flue gas stream.

In some embodiments of the system, the system is configured to further increase a SOx removal efficiency of the at least one filter medium upon introduction of NH₃ into the flue gas stream.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1A depicts an exemplary system with a filter bag comprising a filter medium according to some embodiments of the present disclosure.

FIG. 1B depicts a filter medium according to some embodiments of the present disclosure.

FIG. 1C depicts a porous catalytic layer according to some embodiments of the present disclosure.

FIG. 2 depicts an exemplary SO₂ concentration change upon 1 wt % H₂O₂ injection according to some embodiments of the present disclosure.

FIG. 3 depicts an exemplary NO and NO₂ concentration change upon 1 wt % H₂O₂ injection according to some embodiments of the present disclosure.

FIG. 4A depicts an exemplary SO₂ conversion with 1 wt % H₂O₂ injection at different temperatures according to some embodiments of the present disclosure.

FIG. 4B depicts an exemplary NO to NO₂ conversion with 1 wt % H₂O₂ injection at different temperatures according to some embodiments of the present disclosure.

FIG. 5A depicts an exemplary SO₂ conversion with 0.3 wt % H₂O₂ injection at different temperatures according to some embodiments of the present disclosure.

FIG. 5B depicts an exemplary NO to NO₂ conversion with 0.3 wt % H₂O₂ injection at different temperatures according to some embodiments of the present disclosure.

FIG. 6A depicts an exemplary SO₂ conversion with 0.05 wt % H₂O₂ injection at different temperatures according to some embodiments of the present disclosure.

FIG. 6B depicts an exemplary NO to NO₂ conversion with 0.05 wt % H₂O₂ injection at different temperatures according to some embodiments of the present disclosure.

FIG. 7 depicts is an exemplary optical image of solid particles on a surface of at least one filter medium after NH₃ injection according to some embodiments of the present disclosure.

FIGS. 8A, 8B, 8C, and 8D depict an exemplary SEM/EDX image and elemental mappings of solid particles on a surface of at least one filter medium after NH₃ injection according to some embodiments of the present disclosure.

FIG. 9 depicts an exemplary Fourier-transform infrared spectroscopy (FTIR) of ammonium bisulfate, an exemplary porous protective layer and an exemplary catalytic filter after H₂O₂ injection to a mixture of SO₂ and NH₃ according to some embodiments of the present disclosure.

FIG. 10 depicts an exemplary FTIR of ammonium bisulfate, an exemplary porous protective layer and an exemplary catalytic filter after deionized water injection to the mixture of SO₂ and NH₃ according to some embodiments of the present disclosure.

FIG. 11 depicts an exemplary Fourier-transform infrared spectroscopy (FTIR) of an exemplary catalytic filter after H₂O₂ injection to a mixture of SO₂, NH₃ and dry sorbent according to some embodiments of the present disclosure.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things.

Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or any combination(s) thereof.

As used herein “embedded” means that a first material is distributed throughout a second material.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

All prior patents, publications, and test methods referenced herein are incorporated by reference in their entireties.

As used herein, the term “flue gas stream” refers to a gaseous mixture that comprises at least one byproduct of an industrial process (such as, but not limited to, a coal combustion process, incineration of waste, steel production, cement production, lime production, glass production, industrial boilers, and marine propulsion engines). In some embodiments, a flue gas stream may include at least one gas in an elevated concentration relative to a concentration resulting from the combustion process. For instance, in one non-limiting example, a flue gas stream may be subjected to a “scrubbing” process during which water vapor may be added to the flue gas. Accordingly, in some such embodiments, the flue gas stream may include water vapor in an elevated concentration relative to the initial water vapor concentration due to combustion. Similarly, in some embodiments, a flue gas stream may include at least one gas in a lesser concentration relative to an initial concentration of the at least one gas output from the combustion process. This may occur, for example, by removing at least a portion of at least one gas after combustion. In some embodiments, a flue gas may take the form of a gaseous mixture that is a combination of byproducts of multiple combustion processes.

As used herein, the term “flow through” means that a flue gas stream is flowed transverse to a cross section of the at least one filter medium, such that the flue gas stream passes through a cross section of the at least one filter medium. In some embodiments of a “flow through” configuration, the flue gas stream is flowed perpendicular to a cross-section of the at least one filter medium.

As used herein “upstream” refers to a location of a flue gas stream before entering a filter medium. In the “flow through” context, “upstream” may refer to the location of a flue gas stream before entering a cross section of a filter medium.

As used herein “downstream” refers to a location of a flue gas stream after exiting a filter medium. In the “flow through” context, “downstream” may refer to the location of a flue gas stream after exiting a cross section of a filter medium.

As used herein, the term “NOx compound” refers to any oxide of nitrogen. In some non-limiting embodiments, “NOx compound” may specifically refer to gaseous oxides of nitrogen that are known environmental pollutants.

As used herein, an “oxidizing agent” refers to any form of particulate matter that when added to a flue gas stream, reduces a concentration of at least one component (e.g., at least one NO compound, SO₂, or any combination thereof) of the flue gas stream. This reduction in concentration may occur through oxidation of the at least one component.

As used herein, a “dry sorbent” refers to any form of particulate matter that when added to a flue gas stream or generated from a process involving the flue gas stream, reduces a concentration of at least one component (e.g., at least one SO₂) of the flue gas stream. In some embodiments, examples of a “dry sorbent” generated by a process involving the flue gas stream include, but is not necessarily limited to, calcium carbonate, calcium oxide, cement dust, lime dust, etc. This reduction in concentration may occur through adsorption, by the “dry sorbent,” of the at least one component of the flue gas stream, through absorption, by the “dry sorbent,” of the at least one component of the flue gas stream, through a reaction of the “dry sorbent” with the at least one component of the flue gas stream, or any combination thereof. In some embodiments, the term “dry sorbent” is synonymous with usage of the term within the context of dry sorbent injection (i.e., “DSI”).

Some embodiments of the present disclosure relate to a method. In some embodiments, the method comprises obtaining at least one filter medium.

In some embodiments, the at least one filter medium comprises an upstream side and a downstream side. In some embodiments, the at least one filter medium is disposed within at least one filter bag. In some embodiments, a plurality of filter mediums is disposed within a single filter bag. In some embodiments, the at least one filter bag is housed within at least one filter bag housing. In some embodiments, a plurality of filter bags is disposed within a single filter bag housing.

In some embodiments, the at least one filter medium comprises at least one catalyst material.

In some embodiments, the at least one filter medium comprises a porous protective layer and a porous catalytic layer. In some embodiments, the porous catalytic layer comprises at least one catalyst material. In some embodiments, the at least one catalyst material is disposed on the porous catalytic layer. In some embodiments, the at least one catalyst material is within (e.g., embedded within) the porous catalytic layer.

In some embodiments, the at least one filter medium is in the form of a ceramic candle. In some embodiments, the ceramic candle comprises at least one ceramic material. In some embodiments, the least one ceramic material is chosen from: silica-aluminate, calcium-magnesium-silicate, calcium-silicate fibers, or any combination thereof. In some embodiments, catalyst particles form a coating on the at least one ceramic material.

In some embodiments, the at least one filter medium may comprise any material configured to capture at least one of solid particulates, liquid aerosols, or any combination thereof from a flue gas stream. In some embodiments, the at least one filter medium is in the form of at least one of: a filter bag.

In some embodiments, the at least one catalyst material comprises at least one of: Vanadium Monoxide (VO), Vanadium Trioxide (V₂O₃), Vanadium Dioxide (VO₂), Vanadium Pentoxide (V₂O₅), Tungsten Trioxide (WO₃), Molybdenum Trioxide (MoO₃), Titanium Dioxide (TiO₂), Silicon Dioxide (SiO₂), Aluminum Trioxide (Al₂O₃), Manganese Oxide (MnO₂), Cerium Oxide (CeO₂), Chromium Oxide (CrO₂, Cr₂O₃), at least one zeolite, at least one carbon, or any combination thereof. In some embodiments, the at least one catalyst material is in the form of catalyst particles.

In some embodiments, the porous protective layer comprises a microporous layer. In some embodiments, the microporous layer comprises a protective membrane which is capable to capturing or preventing ingress of particulates. The protective membrane can collect the particulates in a film or cake that can be readily cleaned from the protective membrane, thus providing for easy maintenance of the filter medium. The protective membrane can be constructed from any suitable porous membrane material, such as but not limited to a porous woven or nonwoven membrane, a PTFE woven or nonwoven, an ePTFE membrane, a fluoropolymer membrane, or the like. The protective membrane may be porous or microporous. In some embodiments, the microporous layer comprises an expanded polytetrafluoroethylene (ePTFE) membrane.

In some embodiments, the at least one catalyst material is adhered to the filter medium by at least one adhesive. In some embodiments, the at least one catalyst material is adhered to the porous catalytic layer by at least one adhesive. In some exemplary embodiments, the at least one filter medium is in the form of a filter bag, such that the adherence of the at least one catalyst material to the porous catalytic layer by the at least one adhesive form a coated filter bag. In some embodiments, the at least one catalyst material is in the form of catalyst particles, such that the coated filter bag is coated with the catalyst particles.

In some embodiments, the at least one adhesive is chosen from polytetrafluoroethylene (PTFE), fluorinated ethylene propylene (FEP), high molecular weight polyethylene (HMWPE), high molecular weight polypropylene (HMWPP), perfluoroalkoxy alkane (PFA), polyvinylidene fluoride (PVDF), vinylidene fluoride (THV), chlorofluoroethylene (CFE), or any combination thereof. In some embodiments, the at least one adhesive is selected from the group consisting of polytetrafluoroethylene (PTFE), fluorinated ethylene propylene (FEP), high molecular weight polyethylene (HMWPE), high molecular weight polypropylene (HMWPP), perfluoroalkoxy alkane (PFA), polyvinylidene fluoride (PVDF), vinylidene fluoride (THV), chlorofluoroethylene (CFE), and any combination thereof.

In some embodiments, the porous catalytic layer comprises at least one polymeric substrate. In some embodiments, the at least one polymeric substrate comprises a least one of: polytetrafluorethylene, poly(ethylene-co-tetrafluoroethylene), ultra-high molecular weight polyethylene, polyparaxylylene, polylactic acid, polyimide, polyamide, polyaramid, polyphenylene sulfide, fiberglass, or any combination thereof. In some embodiments, the at least one polymeric substrate is selected from the group consisting of: polytetrafluorethylene, poly(ethylene-co-tetrafluoroethylene), ultra-high molecular weight polyethylene, polyparaxylylene, polylactic acid, polyimide, polyamide, polyaramid, polyphenylene sulfide, fiberglass, and any combination thereof.

In some embodiments, the porous catalytic layer includes at least one ceramic substrate. In some embodiments, the at least one ceramic substrate is in the form of a ceramic candle described herein. In some embodiments, the one ceramic substrate comprises ceramic fibers. In some embodiments, the ceramic fibers comprise alkali metal silicates, alkaline earth metal silicates, alum inosilicates, or any combination thereof.

In some embodiments, the porous catalytic layer is in the form of a layered assembly comprising a porous catalytic film and at least one felt batt. In some embodiments the layered assembly may be a catalytic composite. In some embodiments, the at least one felt batt are positioned on at least one side of the porous catalytic film. In some embodiments, the porous catalytic film comprises a membrane. In some embodiments, the porous catalytic film comprises a polymer membrane. In some embodiments, the porous catalytic film comprises a fluoropolymer membrane and may be referred to as a porous catalytic fluoropolymer film. In some embodiments, the porous catalytic film comprises an expanded polytetrafluoroethylene (ePTFE) membrane.

In some embodiments the porous catalytic film comprises a porous catalytic membrane. In some embodiments, the porous catalytic membrane comprises the at least one catalyst material. In some embodiments, the at least one catalyst material is disposed on the porous catalytic membrane. In some embodiments, the at least one catalyst material is within (e.g., embedded within) the porous catalytic membrane.

In some embodiments, the porous catalytic film comprises a volume fraction where at least 40% of the porosity includes a pore size greater than or about 1 micron, greater than or about 2 microns, greater than or about 3 microns, greater than or about 4 microns, greater than or about 5 microns, greater than or about 6 microns, greater than or about 7 microns, greater than or about 8 microns, greater than or about 9 microns, greater than or about 10 microns, greater than or about 11 microns, greater than or about 12 microns, greater than or about 13 microns, greater than or about 14 microns, or greater than or about 15 microns (as measured by mercury porosimetry).

In some embodiments, the polymer catalytic film may be perforated. As used herein, the term “perforated” refers to perforations (e.g., holes) spaced throughout some or all of the membrane. The porous catalytic film may include or be formed of polytetrafluoroethylene (PTFE), expanded polytetrafluoroethylene (ePTFE), poly(ethylene-co-tetrafluoroethylene) (ETFE), ultrahigh molecular weight polyethylene (UHMWPE), polyethylene, polyparaxylylene (PPX), polylactic acid (PLLA), polyethylene (PE), expanded polyethylene (ePE), and any combination or blend thereof. It is to be understood that throughout this disclosure, the term “PTFE” is meant to include not only polytetrafluoroethylene, but also expanded PTFE, modified PTFE, expanded modified PTFE, and expanded copolymers of PTFE, such as, for example, described in U.S. Pat. No. 5,708,044 to Branca, U.S. Pat. No. 6,541,589 to Baillie, U.S. Pat. No. 7,531,611 to Sabol et al., U.S. Pat. No. 8,637,144 to Ford, and U.S. Pat. No. 9,139,669 to Xu et al. The porous catalytic film may also be formed of one or more monomers of tetrafluoroethylene, ethylene, p-xylene, and lactic acid. In at least one embodiment, the porous catalytic film includes or is formed of solvent inert sub-micron fibers of an expanded fluoropolymer.

In some embodiments, the porous catalytic film is a polytetrafluoroethylene (PTFE) membrane or an expanded polytetrafluoroethylene (ePTFE) membrane having a node and fibril microstructure. In some embodiments, the porous catalytic film comprises catalyst particles enmeshed within the ePTFE membrane. In some embodiments, the ePTFE membrane has a microstructure that includes nodes, fibrils, or any combination thereof. In some embodiments, the catalyst particles may be enmeshed into the microstructure. In some embodiments, the catalyst particles may be enmeshed into the nodes. In some embodiments, the catalyst particles may be enmeshed into the fibrils. In some embodiments, the catalyst particles may be enmeshed into the nodes and fibrils. The fibrils of the PTFE particles interconnect with other PTFE fibrils and/or to nodes to form a net within and around the supported catalyst particles, effectively immobilizing them. Therefore, in one non-limiting embodiment, the porous catalytic film may be formed of a network of PTFE fibrils immobilizing and enmeshing the supported catalyst particles within the fibrillated microstructure.

The porous catalytic film may be formed by blending fibrillating polymer particles with the supported catalyst particles in a manner such as is generally taught in U.S. Pat. No. 7,710,877 to Zhong, et al., United States Publication No. 2010/0119699 to Zhong, et al., U.S. Pat. No. 5,849,235 to Sassa, et al., U.S. Pat. No. 6,218,000 to Rudolf, et al., or U.S. Pat. No. 4,985,296 to Mortimer, Jr., followed by uniaxial or biaxial expansion. As used herein, the term “fibrillating” refers to the ability of the fibrillating polymer to form a node and fibril microstructure. The mixing may be accomplished, for example, by wet or dry mixing, by dispersion, or by coagulation. Time and temperatures at which the mixing occurs varies with particle size, material used, and the amount of particles being co-mixed and are can be determined by those of skill in the art. The uniaxial or biaxial expansion may be in a continuous or batch processes known in those of skill in the art and as generally described in U.S. Pat. No. 3,953,566 to Gore and U.S. Pat. No. 4,478,665 to Hubis.

In some embodiments, the at least one felt batt comprises at least one of: a polytetrafluoroethylene (PTFE) felt, a PTFE fleece, an expanded polytetrafluoroethylene (ePTFE) felt, an ePTFE fleece, a woven fluoropolymer staple fiber, a nonwoven fluoropolymer staple fiber, or any combination thereof. In some embodiments, the at least one felt batt are selected from the group consisting of a polytetrafluoroethylene (PTFE) felt, a PTFE fleece, an expanded polytetrafluoroethylene (ePTFE) felt, an ePTFE fleece, a woven fluoropolymer staple fiber, a nonwoven fluoropolymer staple fiber, and any combination thereof.

In some embodiments the at least one salt formed according to the method of this disclosure comprises ammonium sulfate (AS) ammonium bisulfate (ABS), triammonium hydrogen disulfate (A₃HS₂), ammonium sulfamate (ASM), or any combination thereof. In some embodiments, the at least filter medium comprises ammonium bisulfate (ABS) deposits, ammonium sulfate (AS) deposits, or any combination thereof. In some embodiments, ABS deposits are disposed on the at least one catalyst material of the at least one filter medium. In some embodiments, ABS deposits are disposed within the at least one catalyst material of the at least one filter medium. In some embodiments the ABS deposits are disposed on the upstream surface of the porous protective layer.

In some embodiments, at least some of the ABS deposits, AS deposits, or any combination thereof may be removed, so as to increase a removal efficiency (e.g., NOx removal efficiency, SO₂ removal efficiency or any combination thereof) of the at least one filter medium. In some embodiments, ABS deposits, AS deposits, or any combination thereof may be generated during the method as described herein. In some embodiments, ABS deposits, AS deposits, or any combination thereof may be removed during the method as described herein.

In some embodiments, the ABS deposits are present in a concentration ranging from 0.01% to 99% by mass of the at least one filter medium during the obtaining of the at least one filter medium. In some embodiments, the ABS deposits are present in a concentration ranging from 0.1% to 99%, from 1% to 99%, from 10% to 99%, from 25% to 99%, from 50% to 99%, from 75% to 99% or from 95% to 99% by mass of the at least one filter medium during the obtaining of the at least one filter medium.

In some embodiments, the ABS deposits are present in a concentration ranging from 0.01% to 95%, from 0.01% to 75%, from 0.01% to 50%, from 0.01% to 25%, from 0.01% to 10%, from 0.01% to 1% or from 0.01% to 0.1% by mass of the at least one filter medium during the obtaining of the at least one filter medium.

In some embodiments, the ABS deposits are present in a concentration ranging from 0.1% to 95% by mass of the at least one filter medium during the obtaining of the at least one filter medium. In some embodiments, the ABS deposits are present in a concentration ranging from 1% to 75% by mass of the at least one filter medium during the obtaining of the at least one filter medium. In some embodiments, the ABS deposits are present in a concentration ranging from 10% to 50% by mass of the at least one filter medium during the obtaining of the at least one filter medium.

In some embodiments, the method comprises flowing a flue gas stream transverse to a cross section of the at least one filter medium, such that the flue gas stream passes through the cross section of the at least one filter medium. In some embodiments, flowing the flue gas stream transverse to a cross section of the at least one filter medium comprises flowing the flue gas stream from an upstream side to a downstream side of the at least one filter medium. In some embodiments, flowing the flue gas stream transverse to a cross section of the at least one filter medium comprises flowing the flue gas stream perpendicular to a cross-section of the at least one filter medium.

In some embodiments, the flue gas stream comprises Sulfur Dioxide (SO₂). In some embodiments, the flue gas stream further comprises NOx compounds. In some embodiments, the NOx compounds comprise nitric oxide (NO), nitrogen dioxide (NO₂), or any combination thereof. In some embodiments, the flue gas stream further comprises water (H₂O), nitrogen (N₂), sulfur trioxide (SO₃), carbon monoxide (CO), at least one hydrocarbon, ammonia (NH₃), or any combination thereof.

In some embodiments, the flue gas stream has a temperature that ranges from 100° C. to 300° C. at least during the flowing of the flue gas stream transverse to a cross section of the at least one filter medium. In some embodiments, the flue gas stream has a temperature that ranges from 125° C. to 300° C., from 150° C. to 300° C., from 175° C. to 300° C., from 200° C. to 300° C., from 225° C. to 300° C., from 250° C. to 300° C. or from 275° C. to 300° C. at least during the flowing of the flue gas stream transverse to a cross section of the at least one filter medium.

In some embodiments, the flue gas stream has a temperature that ranges from 100° C. to 275° C., from 100° C. to 250° C., from 100° C. to 225° C., from 100° C. to 200° C., 100° C. to 175° C., from 100° C. to 150° C. or from 100° C. to 125° C. at least during the flowing of the flue gas stream transverse to a cross section of the at least one filter medium.

In some embodiments, the flue gas stream has a temperature that ranges from 125° C. to 275° C. at least during the flowing of the flue gas stream transverse to a cross section of the at least one filter medium. In some embodiments, the flue gas stream has a temperature that ranges from 150° C. to 250° C. at least during the flowing of the flue gas stream transverse to a cross section of the at least one filter medium. In some embodiments, the flue gas stream has a temperature that ranges from 175° C. to 225° C. at least during the flowing of the flue gas stream transverse to a cross section of the at least one filter medium.

In some embodiments, SO₂ is present in the flue gas stream in a concentration from 0.01 ppm to 1000 ppm, from 0.1 ppm to 1000 ppm, from 1 ppm to 1000 ppm, from 10 ppm to 1000 ppm or from 100 ppm to 1000 ppm at least during the flowing of the flue gas stream transverse to a cross section of the at least one filter medium.

In some embodiments, SO₂ is present in the flue gas stream in a concentration from 0.01 ppm to 100 ppm, from 0.01 ppm to 10 ppm, from 0.01 ppm to 1 ppm or from 0.01 ppm to 0.1 ppm at least during the flowing of the flue gas stream transverse to a cross section of the at least one filter medium. In some embodiments, SO₂ is present in the flue gas stream in a concentration from 0.1 ppm to 100 ppm at least during the flowing of the flue gas stream transverse to a cross section of the at least one filter medium. In some embodiments, SO₂ is present in the flue gas stream in a concentration from 1 ppm to 10 ppm at least during the flowing of the flue gas stream transverse to a cross section of the at least one filter medium.

The concentration of SO₂ was measured by a MKS MULTI-GAS™ 2030D Fourier-transform infrared spectroscopy (FTIR) analyzer and an SDL Model 1080-UV analyzer.

In some embodiments, NOx compounds are present in the flue gas stream in a concentration from 0.1 ppm to 5000 ppm, from 1 ppm to 5000 ppm, from 10 ppm to 5000 ppm, from 100 ppm to 5000 ppm or from 1000 ppm to 5000 ppm at least during the flowing of the flue gas stream transverse to a cross section of the at least one filter medium.

In some embodiments, NOx compounds are present in the flue gas stream in an amount from 0.1 ppm to 1000 ppm, from 0.1 ppm to 100 ppm, from 0.1 ppm to 10 ppm or from 0.1 ppm to 1 ppm at least during the flowing of the flue gas stream transverse to a cross section of the at least one filter medium.

In some embodiments, NOx compounds are present in the flue gas stream in a concentration from 1 ppm to 1000 ppm at least during the flowing of the flue gas stream transverse to a cross section of the at least one filter medium. In some embodiments, NOx compounds are present in the flue gas stream in a concentration from 10 ppm to 100 ppm at least during the flowing of the flue gas stream transverse to a cross section of the at least one filter medium.

The concentration of NOx was measured by a MKS MULTI-GAS™ 2030D Fourier-transform infrared spectroscopy (FTIR) analyzer (MKS Instruments, Andover, MA).

In some embodiments, water (H₂O) is present in the flue gas stream in an amount ranging from 0.1 vol % to 50 vol %, from 0.5 vol % to 50 vol %, from 1 vol % to 50 vol %, from 5 vol % to 50 vol %, from 10 vol % to 50 vol %, from 25 vol % to 50 vol % or from 40 vol % to 50 vol % based on a total volume of the flue gas stream at least during the flowing of the flue gas stream transverse to a cross section of the at least one filter medium.

In some embodiments, water (H₂O) is present in the flue gas stream in an amount ranging from 0.1 vol % to 40 vol %, from 0.1 vol % to 25 vol %, from 0.1 vol % to 10 vol %, from 0.1 vol % to 5 vol %, from 0.1 vol % to 1 vol % or from 0.1 vol % to 0.5 vol % based on a total volume of the flue gas stream at least during the flowing of the flue gas stream transverse to a cross section of the at least one filter medium.

In some embodiments, water (H₂O) is present the flue gas stream in an amount ranging from 0.5 vol % to 40 vol %, from 1 vol % to 30 vol % or from 5 vol % to 20 vol % based on a total volume of the flue gas stream at least during the flowing of the flue gas stream transverse to a cross section of the at least one filter medium.

In some embodiments, the method of cleaning the flue gas stream comprises increasing the SO₂ removal efficiency of the at least one filter medium. In some embodiments, increasing the SO₂ removal efficiency of the at least one filter medium comprises introducing at least one oxidizing agent into the flue gas stream.

In some embodiments, increasing the SO₂ removal efficiency of the at least one filter medium comprises introducing ammonia into the flue gas stream.

In some embodiments, increasing the SO₂ removal efficiency of the at least one filter medium comprises introducing at least one oxidizing agent and ammonia into the flue gas stream.

SO₂ removal (conversion) efficiency was calculated according to the SO₂ concentration before and during the introduction of an oxidizing agent (e.g. H₂O₂ injection), SO₂ removal efficiency (“SO₂ conversion”) (%)=((SO₂ without H₂O₂−SO₂ with H₂O₂)/SO₂ without H₂O₂)×100%.

In some embodiments, the SO₂ removal efficiency of the at least one filter medium is increased from 0.1% to 99.9%, from 1% to 99.9%, from 10% to 99.9%, from 25% to 99.9%, from 50% to 99.9, from 75% to 99.9%, from 90% to 99.9%, from 95% to 99.9% or from 99% to 99.9% relative to an initial SO₂ removal efficiency of the at least one filter medium.

In some embodiments, the SO₂ removal efficiency of the at least one filter medium is increased from 0.1% to 99.9%, from 0.1% to 99%, from 0.1% to 95, from 0.1% to 90%, from 0.1% to 75%, 0.1% to 50%, 0.1% to 25%, from 0.1% to 10%, from 0.1% to 10%, from 0.1% to 1 relative to an initial SO₂ removal efficiency of the at least one filter medium.

In some embodiments, the SO₂ removal efficiency of the at least one filter medium is increased from 0.1% to 95%, from 1% to 90%, from 10% to 75% or from 25% to 50% relative to an initial SO₂ removal efficiency of the at least one filter medium.

In some embodiments, increasing the SO₂ removal efficiency of the at least one filter medium comprises introducing at least one oxidizing agent into the flue gas stream.

In some embodiments, the at least one oxidizing agent comprises, consists of, or consists essentially of H₂O₂, or an aqueous solution thereof.

In some embodiments, the at least one oxidizing agent comprises or is selected from the group consisting of: hydrogen peroxide (H₂O₂), ozone (O₃), hydroxyl radical, at least one organic peroxide, at least one metal peroxide, at least one peroxy-acid, at least one percarbonate salt, at least one perborate salt, at least one persulfate salt, at least one permanganate salt, at least one hypochlorite salt, chlorine dioxide (ClO₂), at least one chlorate salt, at least one perchlorate salt, at least one hypochlorite salt, perchloric acid (HClO₄), at least one bismuthate salt, any aqueous solution comprising at least one of the foregoing, or any combination thereof.

Examples of at least one organic peroxide that may be suitable for some embodiments of the present disclosure include, but are not limited to, acetyl acetone peroxide, acetyl benzoyl peroxide, tert-butyl hydroperoxide, di-(1-naphthoyl)peroxide, diacetyl peroxide, ethyl hydroperoxide, methyl ethyl ketone peroxide, methyl isobutyl ketone peroxide, or any combination thereof.

Examples of at least one metal peroxide that may be suitable for some embodiments of the present disclosure include but are not limited to barium peroxide (BaO₂), sodium peroxide (Na₂O₂), or any combination thereof.

Examples of at least one peroxy-acid that may be suitable for some embodiments of the present disclosure include, but are not limited to, peroxymonosulfuric acid (H₂SO₅), peroxynitric acid (HNO₄), peroxymonophosphoric acid (H₃PO₅), or any combination thereof.

Further examples of at least one oxidizing agent that may be suitable for some embodiments of the present disclosure include, but are not limited to, sodium percarbonate (Na₂H₃CO₆), sodium perborate (Na₂H₄B₂O₈), potassium persulfate (K₂S₂O₈), potassium permanganate (KMnO₄), sodium hypochlorite (NaClO), calcium hypochlorite (Ca(ClO)), chlorine dioxide (ClO₂), potassium chlorate (KClO₃), sodium chlorate (NaClO₃), magnesium chlorate (Mg(ClO₃)₂), ammonium perchlorate (NH₄ClO₄), perchloric acid (HClO₄), potassium perchlorate (KClO₄), sodium perchlorate (NaClO₄), sodium chlorite (NaClO₂), lithium hypochlorite (LiOCl), calcium hypochlorite Ca(OCl)₂, barium hypochlorite Ba(ClO)₂, sodium hypochlorite (NaClO), sodium bismuthate (NaBiO₃), or any combination thereof.

In some embodiments, the at least one oxidizing agent is chosen from: hydrogen peroxide (H₂O₂), ozone (O₃), hydroxyl radical or any combination thereof. In some embodiments, the at least one oxidizing agent is selected from the group consisting of: H₂O₂, O₃, hydroxyl radical, or any combination thereof.

In some embodiments, the at least one oxidizing agent is introduced into the flue gas stream in a sufficient amount to convert at least 5% of the SO₂ in the flue gas stream, at least 10% of the SO₂ in the flue gas stream, at least 15% of the SO₂ in the flue gas stream, at least 20% of the SO₂ in the flue gas stream, at least 25% of the SO₂ in the flue gas stream, at least 30% of the SO₂ in the flue gas stream, at least 35% of the SO₂ in the flue gas stream, at least 40% of the SO₂, at least 45% of the SO₂ in the flue gas stream, at least 50% of the SO₂, at least 55% of the SO₂ in the flue gas stream, at least 60% of the SO₂, at least 65% of the SO₂ in the flue gas stream, at least 70% of the SO₂, at least 75% of the SO₂ in the flue gas stream, at least 80% of the SO₂ in the flue gas stream, at least 85% of the SO₂ in the flue gas stream, at least 90% of the SO₂ in the flue gas stream, at least 95% of the SO₂ in the flue gas stream, at least 99% of the SO₂ in the flue gas stream, or at least 99.5% of the SO₂ in the flue gas stream, to SO₃, H₂SO₄, the at least one salt, or any combination thereof. In some embodiments, the at least one oxidizing agent is introduced into the flue gas stream in a sufficient amount to convert all of the SO₂ in the flue gas stream, to SO₃, H₂SO₄, the at least one salt, or any combination thereof. According to some embodiments, SO₂ conversion efficiency can be determined according to the SO₂ concentration change before and during the introduction of an oxidizing agent. It will be understood that the term “conversion efficiency” as used herein means the same as “removal efficiency,” and the terms are interchangeably used herein.

In some embodiments, the sufficient amount of the at least one oxidizing agent that is introduced into the flue gas stream is in a solution form containing 1 wt % to 99 wt % oxidizing agent in water. Thus, a 35% solution contains 35% oxidizing agent and 65% water by weight.

In some embodiments, the sufficient amount of the at least one oxidizing agent that is introduced into the flue gas stream is in a solution form containing 1 wt % to 99 wt % oxidizing agent in water, 0.001 wt % to 40 wt %, 0.001 wt % to 30 wt %, 0.001 wt % to 20 wt %, 0.001 wt % to 10 wt %, 0.001 wt % to 1 wt %, 0.001 wt % to 0.1 wt % or 0.001 wt % to 0.01 wt % In some embodiments, the sufficient amount of the at least one oxidizing agent that is introduced into the flue gas stream is in a solution form containing 1 wt % to 99 wt % oxidizing agent in water, 0.01 wt % to 40 wt %, 0.1 wt % to 30 wt %, 1 wt % to 20 wt % or 5 wt % to 10 wt %. In some embodiments, the sufficient concentration of the at least one oxidizing agent that is introduced into the flue gas stream is 5 ppm to 10000 ppm of the flue gas stream. The concentration of oxidizing agent can be calculated based on the process gas flowrate, the concentration of oxidizing agent and the injection rate of the oxidizing agent. For example, the calculated oxidizing agent (H₂O₂) concentration is 300 ppm when the 30 wt % oxidizing agent (H₂O₂) is injected at 1 ml/hour to a process gas with a flowrate of 1 m³/hour.

In some embodiments, the sufficient concentration of the at least one oxidizing agent that is introduced into the flue gas stream is 10 ppm to 10000 ppm, 50 ppm to 1000 ppm, 100 ppm to 1000 ppm, 500 ppm to 1000 ppm or 800 ppm to 1000 ppm of the flue gas stream. In some embodiments, the sufficient amount of the at least one oxidizing agent that is introduced into the flue gas stream is 5 ppm to 1000 ppm, 5 ppm to 500 ppm, 5 ppm to 100 ppm, 5 ppm to 1000 ppm, 5 ppm to 50 ppm or 5 ppm to 10 ppm of the flue gas stream. In some embodiments, the sufficient concentration of the at least one oxidizing agent that is introduced into the flue gas stream is 10 ppm to 1000 ppm of the flue gas stream. In some embodiments, the sufficient concentration of the at least one oxidizing agent that is introduced into the flue gas stream is 50 ppm to 500 ppm of the flue gas stream.

In some embodiments, the sufficient concentration of the at least one oxidizing agent that is introduced into the flue gas stream is a concentration ratio of the at least one oxidizing agent to SO₂ of 1:10 to 20:1, of 1:5 to 20:1, of 1:2 to 20:1, of 1:1 to 20:1, of 2:1 to 20:1, of 5:1 to 20:1 or of 10:1 to 20:1. In some embodiments, the concentration ratio is based on the concentration of oxidizing agent and the concentration of SO₂.

In some embodiments, the sufficient concentration of the at least one oxidizing agent that is introduced into the flue gas stream is a concentration ratio of the at least one oxidizing agent to SO₂ of 1:10 to 10:1, of 1:10 to 5:1, of 1:10 to 2:1, of 1:10 to 1:1, of 1:10 to 1:2 or of 1:10 to 1:5.

In some embodiments, the sufficient concentration of the at least one oxidizing agent that is introduced into the flue gas stream is a concentration ratio of the at least one oxidizing agent to SO₂ of 1:5 to 10:1. In some embodiments, the sufficient amount of the at least one oxidizing agent that is introduced into the flue gas stream is a concentration ratio of the at least one oxidizing agent to SO₂ of 1:2 to 5:1. In some embodiments, the sufficient amount of the at least one oxidizing agent that is introduced into the flue gas stream is a concentration ratio of the at least one oxidizing agent to SO₂ of 1:1 to 2:1. In some embodiments, the sufficient amount of the at least one oxidizing agent that is introduced into the flue gas stream is a concentration ratio of the at least one oxidizing agent to SO₂ of 6:1 to 20:1.

In some embodiments, introducing the at least one oxidizing agent into the flue gas stream increases a NO₂ concentration to a range from 2% to 99% of a total concentration of the NOx compounds. In some embodiments, introducing the at least one oxidizing agent into the flue gas stream increases a NO₂ concentration to a range from 10% to 99%, from 20% to 99%, from 30% to 99%, from 40% to 99%, from 50% to 99%, from 60% to 99%, from 70% to 99%, from 80% to 99%, from 90% to 99%, from 95% to 99% of a total concentration of the NOx compounds.

In some embodiments, introducing the at least one oxidizing agent into the flue gas stream increases a NO₂ concentration to a range from 2% to 95%, from 2% to 90%, from 2% to 80%, from 2% to 70%, from 2% to 60%, from 2% to 50%, from 2% to 40%, from 2% to 30%, from 2% to 20% or from 2% to 10% of a total concentration of the NOx compounds.

In some embodiments, introducing the at least one oxidizing agent into the flue gas stream increases a NO₂ concentration to a range from 10% to 95%, from 25% to 90% or from 25% to 75% of a total concentration of the NOx compounds.

In some embodiments, the increasing of the NO₂ concentration (e.g., to any range of the total concentration of the NOx compounds described herein) increases a NOx removal efficiency of the at least one filter medium.

The concentration of NO₂ was measured by a MKS MULTI-GAS™ 2030D Fourier-transform infrared spectroscopy (FTIR) analyzer (MKS Instruments, Andover, MA).

In some embodiments, the NOx removal efficiency of the at least one filter medium is increased from 0.001% to 99.9% relative to an initial NOx removal efficiency of the at least one filter medium. In some embodiments, the NOx removal efficiency of the at least one filter medium is increased from 0.01% to 99.9%, from 0.1% to 99.9%, from 1% to 99.9%, from 10% to 99.9%, from 25% to 99.9%, from 50% to 99.9%, from 75% to 99.9%, from 90% to 99.9%, from 95% to 99.9% or from 99% to 99.9% relative to an initial NOx removal efficiency of the at least one filter medium.

In some embodiments, the NOx removal efficiency of the at least one filter medium is increased from 0.001% to 99%, from 0.001% to 95%, from 0.001% to 90%, from 0.001% to 75%, from 0.001% to 50%, from 0.001% to 25%, from 0.001% to 10%, from 0.001% to 1%, from 0.001% to 0.1% or from 0.01% to 0.1% relative to an initial NOx removal efficiency of the at least one filter medium.

In some embodiments, the NOx removal efficiency of the at least one filter medium is increased from 0.01% to 99%, from 0.1% to 95%, from 1% to 90%, from 10% to 75% or from 25% to 50% relative to an initial NOx removal efficiency of the at least one filter medium.

NO to NO₂ conversion efficiency was calculated based on the NO and NO₂ concentration during the introduction of an oxidizing agent (e.g. H₂O₂ injection), NO to NO₂ conversion efficiency (“NO to NO₂ conversion”) (%)=(NO₂/(NO+NO₂))×100%.

In some embodiments, at least some of the SO₂ is reacted with the at least one oxidizing agent to form sulfur trioxide (SO₃), sulfuric acid (H₂SO₄), or any combination thereof. In some embodiments, at least 1 ppm, at least 2 ppm, at least 5 ppm, at least 10 ppm, at least 20 ppm, at least 50 ppm, at least 100 ppm, at least 1000 ppm or at least 10,000 ppm of the SO₂ is reacted with the at least one oxidizing agent to form sulfur trioxide (SO₃), sulfuric acid (H₂SO₄), or any combination thereof.

In some embodiments, increasing the SO₂ removal efficiency of the at least one filter medium comprises introducing ammonia (NH₃) into the flue gas stream. In some embodiments, introducing the NH₃, into the flue gas stream is performed after introducing the at least one oxidizing agent into the flue gas stream. In some embodiments, introducing the NH₃ into the flue gas stream is performed before introducing the at least one oxidizing agent into the flue gas stream, during the introducing of the at least one oxidizing agent into the flue gas stream, or any combination thereof. In some embodiments, introducing the NH₃ is performed by newly adding NH₃ into the system or the process. In some embodiments, introducing the NH₃ is performed by adding NH₃ sourced from downstream of the system or the process, wherein the NH₃ is already in the system or is already a part of the process.

In some embodiments, the NH₃ is introduced into the flue gas stream in a concentration ranging from 0.0001% to 0.5% of the concentration of the flue gas stream. In some embodiments, the NH₃ is introduced into the flue gas stream in a concentration ranging from 0.001% to 0.5% of the concentration of the flue gas stream. In some embodiments, the NH₃ is introduced into the flue gas stream in a concentration ranging from 0.01% to 0.5% of the concentration of the flue gas stream. In some embodiments, the NH₃ is introduced into the flue gas stream in a concentration ranging from 0.1% to 0.5% of the concentration of the flue gas stream.

In some embodiments, the NH₃ is introduced into the flue gas stream in a concentration ranging from 0.0001% to 0.1% of the concentration of the flue gas stream. In some embodiments, the NH₃ is introduced into the flue gas stream in a concentration ranging from 0.0001% to 0.01% of the concentration of the flue gas stream. In some embodiments, the NH₃ is introduced into the flue gas stream in a concentration ranging from 0.0001% to 0.001% of the concentration of the flue gas stream.

In some embodiments, the NH₃ is introduced into the flue gas stream in a concentration ranging from 0.001% to 0.01% of the concentration of the flue gas stream. In some embodiments, the NH₃ is introduced into the flue gas stream in a concentration ranging from 0.001% to 0.1% of the concentration of the flue gas stream. In some embodiments, the NH₃ is introduced into the flue gas stream in a concentration ranging from 0.01% to 0.1% of the concentration of the flue gas stream.

The concentration of NH₃ was measured by a MKS MULTI-GAS™ 2030D Fourier-transform infrared spectroscopy (FTIR) analyzer (MKS Instruments, Andover, MA).

In some embodiments, the ammonia (NH₃) is introduced into the flue gas stream in a concentration ratio of NH₃ to NOx compounds of 7:200 to 9:5. In some embodiments, the ammonia (NH₃) is introduced into the flue gas stream in a concentration ratio of NH₃ to NOx compounds of 21:40 to 9:5, of 7:10 to 9:5, of 4:5 to 9:5, of 9:10 to 9:5 or of 1:1 to 9:5.

In some embodiments, the ammonia (NH₃) is introduced into the flue gas stream in a concentration ratio of NH₃ to NOx compounds of 7:200 to 1:1, of 7:200 to 9:10, of 7:200 to 4:5, of 7:200 to 7:10 or of 21:400 to 7:10.

In some embodiments, the ammonia (NH₃) is introduced into the flue gas stream in a concentration ratio of NH₃ to NOx compounds of 7:10 to 1:1. In some embodiments, the ammonia (NH₃) is introduced into the flue gas stream in a concentration ratio of NH₃ to NOx compounds of 21:40 to 9:5.

In some embodiments the ammonia (NH₃) is reacted with at least some of the sulfur trioxide (SO₃), at least some of the sulfuric acid (H₂SO₄), or any combination thereof, so as to form at least one salt.

In some embodiments, ammonia (NH₃) is introduced into the flue gas stream, so as to react with at least 1 ppm of the sulfur trioxide (SO₃) and form at least one salt. In some embodiments, ammonia (NH₃) is introduced into the flue gas stream, so as to react with at least 2 ppm, at least 5 ppm, at least 10 ppm, at least 50 ppm, at least 100 ppm, at least 1000 ppm or at least 10,000 ppm of the sulfur trioxide (SO₃) and form at least one salt.

In some embodiments, ammonia (NH₃) is introduced into the flue gas stream, so as to react with at least 1 ppm of the sulfuric acid (H₂SO₄) and form at least one salt. In some embodiments, ammonia (NH₃) is introduced into the flue gas stream, so as to react with at least 2 ppm, at least 5 ppm, at least 10 ppm, at least 50 ppm, at least 100 ppm, at least 1000 ppm or at least 10,000 ppm of the sulfuric acid (H₂SO₄) and form at least one salt.

In some embodiments, the at least one salt comprises or is selected from the group consisting of ammonium sulfate (AS) ammonium bisulfate (ABS), triammonium hydrogen disulfate (A₃HS₂), ammonium sulfamate (ASM), or any combination thereof. In some embodiments, the at least one salt comprises or is selected from the group consisting of ammonium sulfate (AS) ammonium bisulfate (ABS), or any combination thereof.

In some embodiments, the method comprises removing the at least one salt from the at least one filter medium (e.g., from at least one surface of the at least one filter medium). In some embodiments, removing the at least one salt from the at least one filter medium comprises removing the at least one salt from the porous protective layer of the at least one filter medium. In some embodiments, removing the at least one salt from the at least one filter medium comprises removing the at least one salt from the at least one felt batt of the at least one filter medium. In some embodiments, removing the at least one salt from the at least one filter medium does not comprise removing the at least one salt from the porous catalytic layer of the at least one filter medium.

In some embodiments, a higher amount of the at least one salt is formed on the porous protective layer of the at least one filter medium as compared to an amount of the at least one salt formed on the porous catalytic layer of the at least one filter medium. In some embodiments, at least 10% more of the at least one salt is formed on the porous protective layer of the at least one filter medium as compared to an amount of the at least one salt formed on the porous catalytic layer of the at least one filter medium. In some embodiments, at least 20% more, at least 30% more, at least 40% more, at least 50% more, at least 60% more, at least 70% more, at least 80% more or at least 90% more of the at least one salt is formed on the porous protective layer of the at least one filter medium as compared to an amount of the at least one salt formed on the porous catalytic layer of the at least one filter medium. In some embodiments, an amount of ABS on a filter material with a porous protective layer is compared to the amount of ABS in a filter material without porous protective layer, wherein this comparison can be by weight measurement of these two before and after treatment.

In some embodiments, the method comprises introducing at least one dry sorbent into the flue gas stream so as to react with at least some of the sulfur trioxide (SO₃), with at least some of the sulfuric acid (H₂SO₄), or any combination thereof. In some embodiments, reacting at least some of the sulfur trioxide (SO₃), at least some of the sulfuric acid (H₂SO₄), or any combination thereof, with the at least one dry sorbent forms the at least one salt described herein.

In some embodiments, the method includes obtaining a filter medium, wherein the filter medium has a catalyst material. In some embodiments, the method includes flowing a flue gas stream transverse to a cross section of the filter medium, such that the flue gas stream passes through the cross section of the filter medium, wherein the flue gas stream comprises sulfur dioxide (SO₂). In some embodiments, a SO₂ removal efficiency of the filter medium is increased by introducing at least one oxidizing agent into the flue gas stream, so as to react at least some of the SO₂ with the at least one oxidizing agent to form sulfur trioxide (SO₃), sulfuric acid (H₂SO₄), or any combination thereof, and introducing at least one dry sorbent into the flue gas stream, so as to react at least some of the sulfur trioxide (SO₃), at least some of the sulfuric acid (H₂SO₄), or any combination thereof, with the at least one dry sorbent and form at least one salt. In some embodiments, the method includes introducing ammonia (NH₃) into the flue gas stream, so as to react at least some of the sulfur trioxide (SO₃), at least some of the sulfuric acid (H₂SO₄), or any combination thereof, with the ammonia (NH₃) and forming at least one salt.

In some embodiments, a system includes a filter medium. In some embodiments, the filter medium includes an upstream side; a downstream side; at least one catalyst material; at least one filter bag, wherein the at least one filter medium is disposed within the at least one filter bag; and at least one filter bag housing, wherein the at least one filter bag is disposed within the at least one filter bag housing. In some embodiments of the filter medium, the at least one filter bag housing is configured to receive a flow of a flue gas stream transverse to a cross section of the at least one filter medium, such that the flue gas stream passes through the cross section of the at least one filter medium from the upstream side of the at least one filter medium to the downstream side of the at least one filter medium. In some embodiments, the flue gas stream comprises sulfur dioxide (SO₂), and the embodiments of the system are configured to increase a SOx removal efficiency of the at least one filter medium upon introduction of at least one oxidizing agent into the flue gas stream; and introduction of at least one dry sorbent into the flue gas stream. In some embodiments, the system is configured to further increase a SOx removal efficiency of the at least one filter medium upon introduction of NH₃ into the flue gas stream.

In some embodiments, the at least one dry sorbent comprises or is selected from the group consisting of sodium bicarbonate, trona, calcium hydroxide, calcium carbonate, calcium oxide, cement dust, lime, or any combination thereof.

In some embodiments, introducing the at least one dry sorbent into the flue gas stream is performed after introducing the at least one oxidizing agent into the flue gas stream. In some embodiments, introducing the at least one dry sorbent into the flue gas stream is performed before introducing the at least one oxidizing agent into the flue gas stream, during the introducing of the at least one oxidizing agent into the flue gas stream, or any combination thereof.

Some embodiments of the present disclosure relate to a system. In some embodiments, the system comprises the at least one filter medium described herein, which may, in some embodiments, comprise an upstream side, a downstream side, and at least one catalyst material. In some embodiments, the at least one filter medium is disposed within at least one filter bag. In some embodiments, the at least one filter bag is disposed within at least one filter bag housing,

In some embodiments, the at least one filter bag housing is configured to receive a flow of a flue gas stream transverse to a cross section of the at least one filter medium, such that the flue gas stream passes through the cross section of the at least one filter medium from the upstream side of the at least one filter medium to the downstream side of the at least one filter medium.

In some embodiments, the system is configured to increase a SOx removal efficiency of the at least one filter medium upon introduction of at least one oxidizing agent into the flue gas stream.

In some embodiments, the system is configured to introduce ammonia (NH₃) into the flue gas stream.

In some embodiments, the system is configured to introduce at least one dry sorbent into the flue gas stream.

In some embodiments, the system is configured to increase a SOx removal efficiency of the at least one filter medium upon introduction of:
at least one oxidizing agent into the flue gas stream;
ammonia (NH₃) into the flue gas stream;
at least one dry sorbent into the flue gas stream; or
any combination thereof.

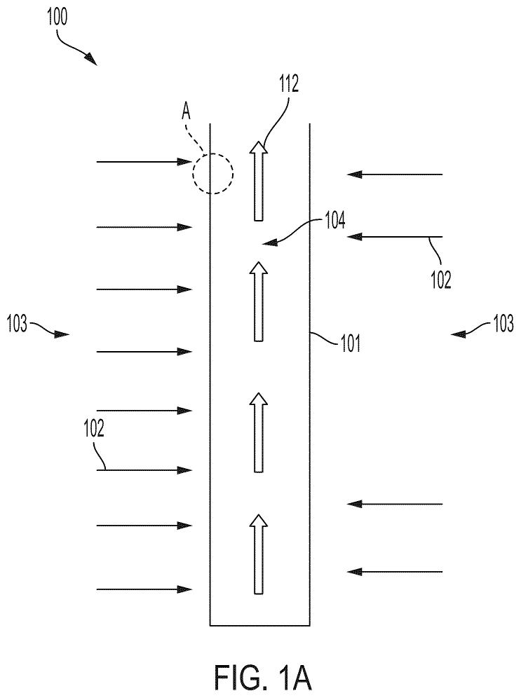

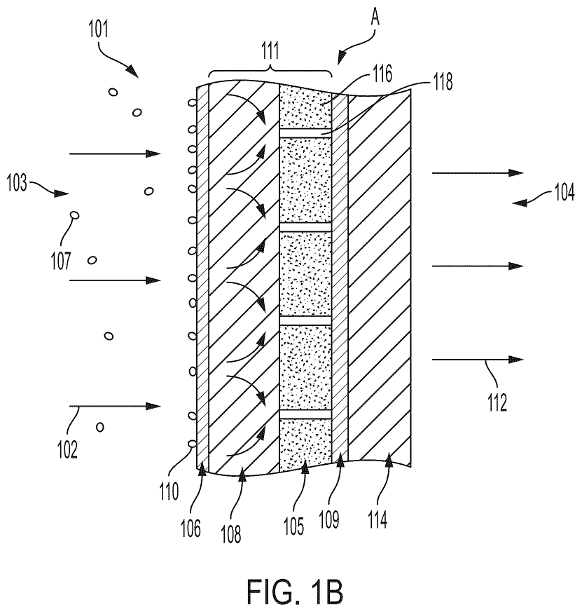

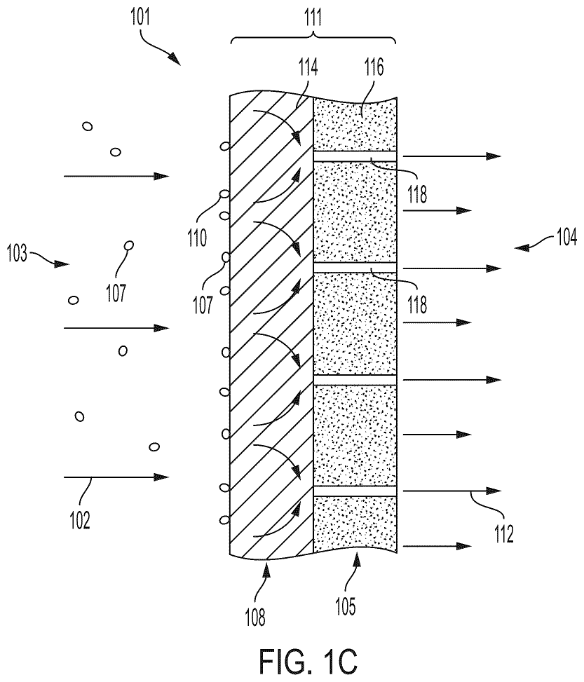

FIGS. 1A-1C depict non-limiting embodiments of an exemplary system according to the present disclosure.

Referring to FIG. 1A, in some embodiments, the system may comprise at least one filter medium 101 that is housed in at least one filter bag 100. In some embodiments, filter bag 100 or a series of filter bags may also be housed in at least one filter bag housing (not shown). A flue gas stream 102 may flow through the at least one filter medium 101 by passing through cross section A. Once the flue gas stream 102 flows through the at least one filter medium 101, the outgoing flue gas stream 112 may exit the at least one filter bag, as indicated by the vertically oriented arrows. An upstream direction 103 is defined in terms of the prevailing direction of incoming fluid flow 102, and a downstream direction 104 is defined in terms of a prevailing direction of outgoing fluid flow 104. As shown in FIG. 1A, the upstream side 103 of the filter medium 101 may, in some embodiments, correspond to an outside of a filter bag, such as filter bag 100. Likewise, downstream side 104 of the filter medium 101 may correspond to an inside of a filter bag, such as filter bag 100.

FIG. 1B depicts an exemplary filter medium 101 according to some embodiments of the present disclosure. As shown in FIG. 1B, a flue gas stream 102, which may comprise SO₂ and NOx compounds and solid particulates 107, may flow through cross section A (as shown in FIG. 1A) from an upstream side 103 of the filter medium 101 to a downstream side 104 of the filter medium. In some embodiments, filter medium 101 may include at least one porous protective layer 106 and at least one felt batt 108 on the upstream side 103 the of the filter medium 101 In some embodiments, the at least one felt batt 108 may be positioned on a porous catalytic film 105. In some embodiments, the combination of the at least one felt batt 108 and the porous catalytic film 105 may be referred to as a porous catalytic layer 111.

In one embodiment, the filter medium 101 and components thereof can be described in terms of an upstream side 103 facing an incoming fluid flow 102, and a downstream side 104 from which an outgoing fluid flow 112 originates. FIG. 1B shows a porous catalytic film 105 layered with a first felt batt 108 and a protective porous layer 106 in an upstream direction 103 from the porous catalytic film 105; with a supportive scrim 109 and a second felt batt 114 positioned in a downstream direction 104. The filter medium 101 is capable of filtering particulates 107, which may be suspended in the incoming fluid flow 102 and also to reduce or remove chemical contaminants via a catalyzed reaction at the porous catalytic film 105 in the porous catalytic layer 111. In some embodiments the method of the disclosure forms at least one salt 110 which comprises ammonium sulfate (AS), ammonium bisulfate (ABS), triammonium hydrogen disulfate (A₃HS₂), ammonium sulfamate (ASM), or any combination thereof. The salt 110 might be collected on the upstream surface of the porous protective layer 106.

The porous catalytic film 105 includes an intact portion 116 broken by perforations 118. The perforations 118 can be formed by way of a needling operation; or alternatively, by needle punching operation. The construction of the adjacent porous catalytic film 105 and first felt batt 108 provide for circulation of the incoming fluid flow 102 within the internal structure of the first felt batt, near the enmeshed catalytic particles of the porous catalytic film 105, prior to the fluid passing through the porous catalytic film 105 at the perforations 118 or via pores in the intact portion 116.

In one embodiment, a porous protective layer 106 is positioned on an upstream side of the first felt batt 108 and is capable to capturing or preventing ingress of particulates 107 and salt 110 as reaction product of the method of this disclosure. The porous protective layer 106 can capture particulates (e.g., dust, soot, ash, or the like) and salt 110 to prevent entry of particles into the porous catalytic film 105 or felt batt 105 to prevent or minimize clogging of the perforations 118 of the film and prevent or minimize fouling of the porous polymer membrane that might block access to the supported catalytic particles enmeshed therein. The porous protective layer 106 can collect the particulates 107 and salt 110 in a film or cake that can be readily cleaned from the porous protective layer 106, thus providing for easy maintenance of the filter medium 101. The porous protective layer 106 can be constructed from any suitable porous membrane material, such as but not limited to a porous woven or nonwoven membrane, a PTFE woven or nonwoven, an ePTFE membrane, a fluoropolymer membrane, or the like. The porous protective layer 106 can be connected with the first felt batt 108 by way of laminating, heat treating, discontinuous or continuous adhesives, or other suitable joining method.

In accordance with at least one embodiment, the porous catalytic film 105 is supported by a scrim 109 that provides structural support without significantly affecting the overall fluid permeability of the filter medium 101. The scrim 109 can be any suitable, porous backing material capable of supporting the filter medium 101. The scrim can be, for example, a fluoropolymer woven or nonwoven, a PTFE woven or nonwoven, or in one specific embodiment, a woven made from ePTFE fibers (e.g. 440 decitex RASTEX® fiber, available from W. L. Gore and Associates, Inc., Elkton, MD.). The scrim 109 may be disposed downstream 104 of the porous catalytic film 105, e.g., downstream and adjacent the porous catalytic film 105, or alternatively, downstream and separated from the porous catalytic film 105 by one or more additional layers. Scrim 109 may be connected to the porous catalytic film 105 by a needling or needle punching operation. The scrim 105 may also, or alternatively, be connected with the porous catalytic film 105 by way of a heat treatment, by one or more connectors that press the layers together, or by an adhesive, e.g., a thin adhesive layer (which may be continuous or discontinuous) between the scrim 105 and porous catalytic film 105, or by any suitable combination of two or more of the above methods, including a needling or needle punching operation. Generally, the scrim 109 has higher air permeability than the porous catalytic film 105.

In one embodiment, the filter medium 101 can further include a second felt batt 114 positioned in the downstream direction 104 from the porous catalytic film 105. The second felt batt 114 can have a similar construction and dimensions as the first felt batt 108, e.g., the second felt batt can include or be composed of any suitable woven or nonwoven, such as but not limited to a staple fiber woven or nonwoven, a PTFE staple fiber woven or nonwoven, or a fluoropolymer staple fiber woven or nonwoven. For example, the second felt batt 114 can be a PTFE fiber felt or a PTFE fiber fleece.

The porous catalytic film 105, scrim 109, and the first and second felt batts 108, 114 may be connected together via a needling or needle punching operation, or a combination of the these techniques. In one embodiment, the porous catalytic film 105 alone is perforated because the perforations provide for suitable fluid flow across the porous catalytic film 105, whereas the other layers are generally more permeable to airflow than the porous catalytic film 105 and do not require any perforation. Some or all of the layers may be further connected via heat treatment, adhesive, or another suitable connection method. The porous protective layer 106 may be attached to the remaining layers of the filter medium 101 by adhesion, heat treatment, or another method that does not result in perforations of the porous protective layer 106. Alternatively, the porous protective layer 106 can be connected with the remaining layers of the filter medium 101 via needling or needle punching.

FIG. 1C depicts an additional non-limiting exemplary embodiment of a filter medium 101. As shown, filter medium 101 may comprise a porous catalytic layer 111. In some non-limiting embodiments, filter medium 101 may take the form of a filter bag. In some embodiments the porous catalytic layer 111 may be coated with a catalyst material (not shown in FIG. 1C) such as catalyst particles. In some embodiments, the catalyst material may be attached to the porous catalytic layer 111 by one or more adhesives described herein (not shown). The porous catalytic layer 111 includes a porous catalytic film 105 and a felt batt 108. An upstream direction 103 is defined in terms of the prevailing direction of incoming fluid flow 102, and a downstream direction 104 is defined in terms of a prevailing direction of outgoing fluid flow 112. The felt batt 108 is positioned upstream of the porous catalytic film 105, and is operable to collect particulates 107 (e.g., dust and the like) from the incoming fluid flow 102. In some embodiments described herein, the porous catalytic film 105 comprises perforations therein. The perforated porous catalytic film 105 permits fluid to pass readily through the catalytic composite while still interacting sufficiently with the supported catalyst particles durably enmeshed within the porous polymer membrane to remediate contamination in the fluid stream. The catalytic material of the porous catalytic film 105 is selected to target specific contaminant species. For example, the supported catalyst particles of the porous catalytic film 105 can include some combination of, or all of, the catalytic species TiO₂, V₂O₅, WO₃, suitable for catalyzing the reduction or removal of NOx species such as NO, NO₂, to water and nitrogen gas, as illustrated in FIG. 1C. However, other catalytic materials may be substituted or included that are suitable for conversion of different contaminants, e.g., for remediating carbon monoxide (CO), Dioxin/Furan, ozone (O₃), volatile organic compounds (VOC), and other contaminants.

The felt batt 108 can include any suitable, porous structure capable of filtering particulate contaminants 107 and salts 110 as reaction product of the method according to this disclosure; as well as moderating the incoming fluid flow 102 for introduction to the porous catalytic film 105. The felt batt 108 can be formed of any suitable woven or nonwoven having a highly porous interior structure, such as, but not limited, to a staple fiber woven or nonwoven, a PTFE staple fiber woven or nonwoven, a fleece formed from a fluoropolymer staple fiber, or a fluoropolymer staple fiber woven or nonwoven. In one embodiment, the felt batt 105 is a PTFE fiber felt, or a PTFE fiber fleece.

In at least one embodiment, the component layers of the porous catalytic layer 111 are connected together by way of the needling or needle-punching operation, i.e., a needle or punch can be pressed through both of the assembled felt batt 108 and porous catalytic film 105 in order to locally deform the layers to hold the layers in contact with each other. In general, a needling operation penetrates and deforms the material, while a needle punching operation also removes a small plug of material; but both operations may be referred to as “needling”. Layers in the porous catalytic layer 111 may also be held together by lamination or applied heat treatment, by adhesives (typically discontinuous adhesives so as to retain porosity), by external connectors, by weaving or other comparable connective means, or by any suitable combination of the above. In one embodiment, the component layers of the porous catalytic layer 111 are combined by needling and/or needle punching, followed by a subsequent heat treatment to set the composite and form the catalytic composite. Alternatively, the component layers of the porous catalytic layer 111 can be combined by pressing the layers together after the perforations have been applied to the porous catalytic film 105, and subsequently heat treating the layered assembly to form the catalytic composite.

Test Methods

The concentration of NO, NO₂, NH₃, and SO₂ before, during and after the H₂O₂ injection and/or addition of ammonia and/or dry sorbent in example 1-6 and comparative example 1 was measured by a MKS MULTI-GAS™ 2030D Fourier-transform infrared spectroscopy (FTIR) analyzer (MKS Instruments, Andover, MA). The concentration of SO₂ before, and during the H₂O₂ injection and/or addition of ammonia and/or dry sorbent in example 7 was measured by an SDL Model 1080-UV analyzer.

The SO₂ conversion efficiency was calculated according to the SO₂ concentration before and during the H₂O₂ injection:

SO₂ conversion efficiency (“SO₂ conversion”)(%)=((SO₂ without H₂O₂−SO₂ with H₂O₂)/SO₂ without H₂O₂)×100%.

The NO to NO₂ conversion efficiency was calculated based on the NO and NO₂ concentration during the H₂O₂ injection:

NO to NO₂ conversion efficiency(“NO to NO₂ conversion”)(%)=(NO₂/(NO+NO₂))×100%.

NOx removal efficiency was calculated based on the following equation:

NOx removal efficiency(“DeNOx efficiency”)(%)=((NOx in−NOx out)/NOx in)×100%.

### EXAMPLES

The examples 1 to 3 demonstrating the effect of reducing SO₂ by adding an oxidizing agent to a flue gas mixture:

### Example 1: Injection of 1 wt % H₂O₂ Solution into a Gas Mixture of SO₂ and NO

A syringe pump was used to inject 1 wt % H₂O₂ solution (oxidizing agent) at a speed of 12.0 ml/hour to a 3.19 L/min flue gas stream comprising 35 ppm SO₂ and 200 ppm NO at temperatures of 174° C., 189° C., 195° C., and 204° C. The H₂O₂ concentration in the gas stream is about 630 ppm. The ratio of H₂O₂ concentration over SO₂ concentration in the gas stream is about 18. The concentration of NO, NO₂ and SO₂ before, during and after the H₂O₂ injection was measured by a MKS MULTI-GAS™ 2030D Fourier-transform infrared spectroscopy (FTIR) analyzer (MKS Instruments, Andover, MA).

SO₂ conversion efficiency was calculated according to the SO₂ concentration before and during the H₂O₂ injection, SO₂ conversion efficiency (“SO₂ conversion”) (%)=((SO₂ without H₂O₂−SO₂ with H₂O₂)/SO₂ without H₂O₂)×100%.

NO to NO₂ conversion efficiency was calculated based on the NO and NO₂ concentration during the H₂O₂ injection, NO to NO₂ conversion efficiency (“NO to NO₂ conversion”) (%)=(NO₂/(NO+NO₂))×100%.

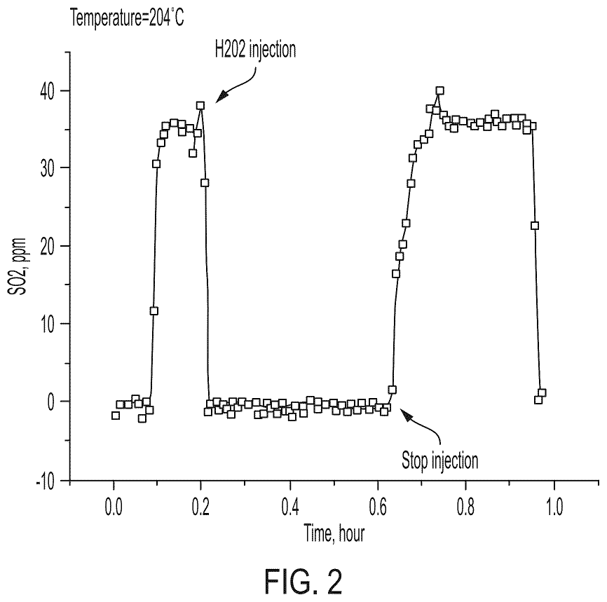

Results are shown in FIGS. 2-4.

FIG. 2 shows the SO₂ concentration change in the flue gas stream upon 1 wt % H₂O₂ injection according to example 1. The SO₂ concentration change is illustrated by a flue gas stream temperature of 204° C. The H₂O₂ injection was taken over a time of 0.5 hour which lead to the decrease of the SO₂ concentration from 35 ppm to 0 ppm in the flue gas stream. The SO₂ conversion efficiency is about 100%.

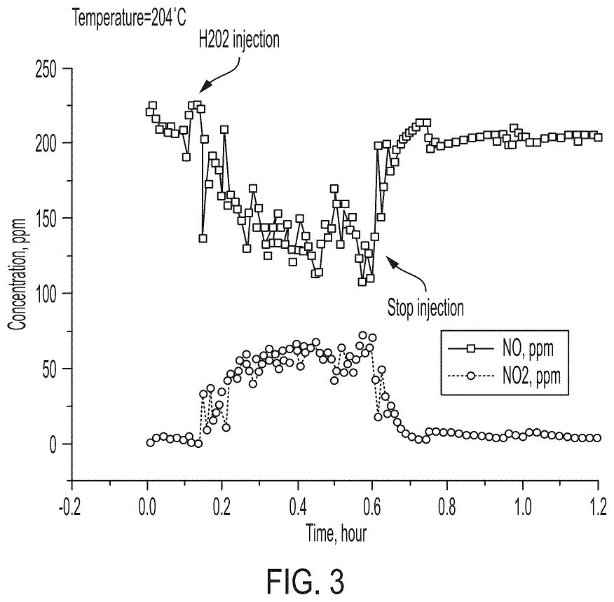

FIG. 3 shows the NO and NO₂ concentration change upon 1 wt % H₂O₂ injection according to example 1. The NO and NO₂ concentration change is illustrated by a flue gas stream temperature of 204° C. The H₂O₂ injection was taken over a time of 0.5 hour which lead to the decrease of the NO concentration from 200 ppm to 125 ppm, and the increase of the NO₂ concentration from 0 ppm to 60 ppm in the flue gas stream. The NO to NO₂ conversion efficiency is about 32.4%.

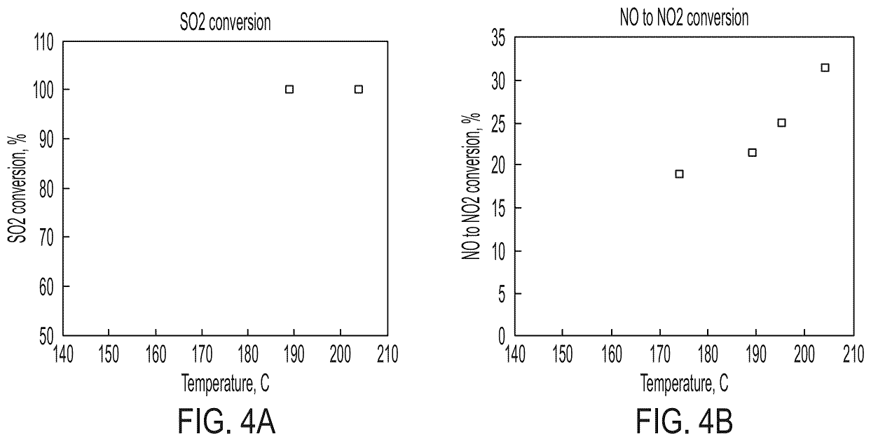

FIG. 4A shows a diagram for the SO₂ conversion efficiency in % with 1 wt % H₂O₂ injection at different temperatures. At the temperatures of 189° C. and 204° C. 100% of the SO₂ has been removed from the flue gas stream.

FIG. 4B shows a diagram for the NO to NO₂ conversion efficiency in % with 1% H₂O₂ injection at different temperatures.

The above mentioned four data points at four different temperatures showing an increase of NO₂ up to 30% in the flue gas stream.

### Example 2: Injection of 0.3 wt % H₂O₂ Solution into a Gas Mixture of SO₂ and NO

A syringe pump was used to inject 0.3 wt % H₂O₂ solution at a speed of 12.0 ml/hour to a 3.19 L/min gas stream contains of 35 ppm SO₂ and 200 ppm NO at temperatures of 152° C. and 190° C. The H₂O₂ concentration in the gas stream is about 190 ppm. The ratio of H₂O₂ concentration over SO₂ concentration in the gas stream is about 5.4. The concentration of NO, NO₂ and SO₂ before, during and after the H₂O₂ injection was measured by a MKS MULTI-GAS™ 2030D Fourier-transform infrared spectroscopy (FTIR) analyzer (MKS Instruments, Andover, MA).

SO₂ conversion efficiency was calculated according to the SO₂ concentration before and during the H₂O₂ injection, SO₂ conversion efficiency (“SO₂ conversion”) (%)=((SO₂ without H₂O₂−SO₂ with H₂O₂)/SO₂ without H₂O₂)×100%.

NO to NO₂ conversion efficiency was calculated based on the NO and NO₂ concentration during the H₂O₂ injection, NO to NO₂ conversion efficiency ((“NO to NO₂ conversion”) (%)=NO₂/(NO+NO₂))×100%.

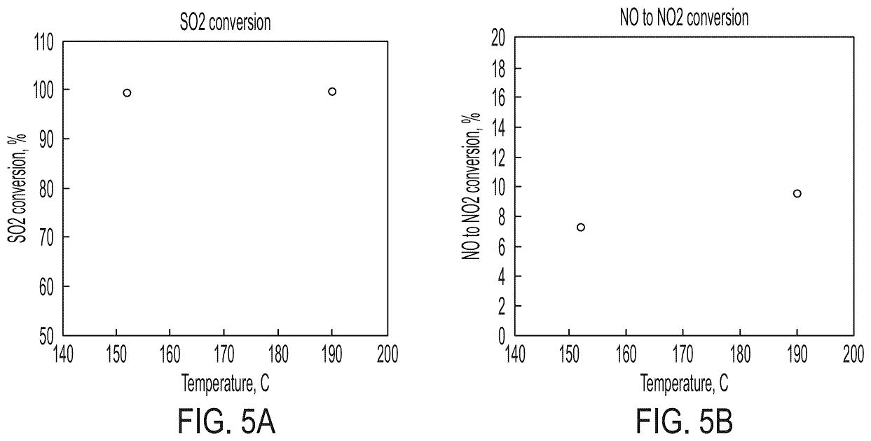

Results are shown in FIGS. 5A and 5B. FIG. 5A shows a diagram for the SO₂ conversion efficiency with 0.3 wt % H₂O₂ injection at 152° C. and 190° C. In this example 100% SO₂ conversion is achieved.

FIG. 5B shows a diagram for the NO and NO₂ conversion efficiency with 0.3 wt % H₂O₂ injection at 152° C. and 190° C. The overall NO₂ conversion efficiency is smaller than in FIG. 4B but increasing from about 7% up to 10%.

### Example 3: Injection of 0.05 wt % H₂O₂ Solution into a Gas Mixture of SO₂ and NO

A syringe pump was used to inject 0.05 wt % H₂O₂ solution at a speed of 12.0 ml/hour to a 3.19 L/min flue gas stream comprising 35 ppm SO₂ and 200 ppm NO at temperatures of 170° C., 208° C., and 214° C. The H₂O₂ concentration in the gas stream is about 30 ppm. The ratio of H₂O₂ concentration over SO₂ concentration in the gas stream is about 0.86. The concentration of NO, NO₂, and SO₂ before, during, and after the H₂O₂ injection was measured by a MKS MULTI-GAS™ 2030D Fourier-transform infrared spectroscopy (FTIR) analyzer (MKS Instruments, Andover, MA).

SO₂ conversion efficiency was calculated according to the SO₂ concentration before and during the H₂O₂ injection, SO₂ conversion efficiency ((“SO₂ conversion”) (%)=(SO₂ without H₂O₂−SO₂ with H₂O₂)/SO₂ without H₂O₂)×100%.

NO to NO₂ conversion efficiency was calculated based on the NO and NO₂ concentration during the H₂O₂ injection, NO to NO₂ conversion efficiency ((“NO to NO₂ conversion”) (%)=NO₂/(NO+NO₂))×100%.

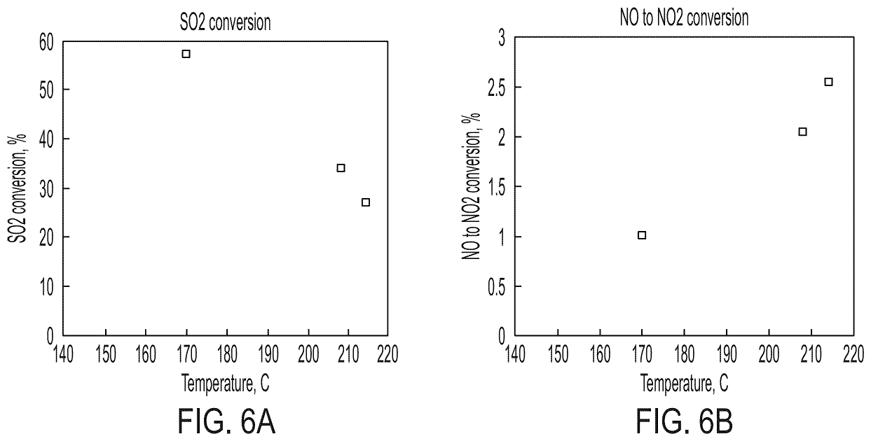

Results are shown in FIGS. 6A and 6B.

FIG. 6A shows a diagram for the SO₂ conversion efficiency with 0.05 wt % H₂O₂ injection at different temperatures. The concentration of H₂O₂ allows a SO₂ conversion of about 55% in the flue gas stream at 170° C. and is further decreasing with higher temperatures.

FIG. 6B shows a diagram for the NO and NO₂ conversion efficiency with 0.05 wt % H₂O₂ injection at different temperatures. The conversion rates for NO₂ are increasing with increasing temperatures but at a lower lever that in FIGS. 4B and 5B.

### Example 4: Injection of NH 3 and 1 wt % H₂O₂ Solution into a Gas Mixture of NO and SO₂ (No Upstream Porous Protective Layer)

A catalytic filter medium was formed according to International Patent Publication No. WO 2019/099025 to Eves et al. The filter medium comprises a porous catalytic layer having a catalytic layered assembly that includes a downstream oriented porous catalytic film and an upstream oriented felt batt. The felt batt was formed of fleece formed from PTFE staple fiber. The filter medium was connected together by a plurality of perforations formed by a needle punching process, by a needling process, or both. FIG. 1C represents an exemplary embodiment of a filter medium according to this example.

The porous catalytic film of the filter medium described above was prepared using the general dry blending methodology taught in U.S. Pat. No. 7,791,861 B₂ to Zhong et al. to form composite tapes that were then uniaxially expanded according to the teachings of U.S. Pat. No. 3,953,556 to Gore. The resulting porous fibrillated expanded PTFE (ePTFE) composite membranes included supported catalyst particles durably enmeshed and immobilized with the ePTFE node and fibril matrix.

Such filter medium in the form of filter bags is commercially available by W.L. Gore & Associates under the name GORE® DeNOx Catalytic Filter Bags.

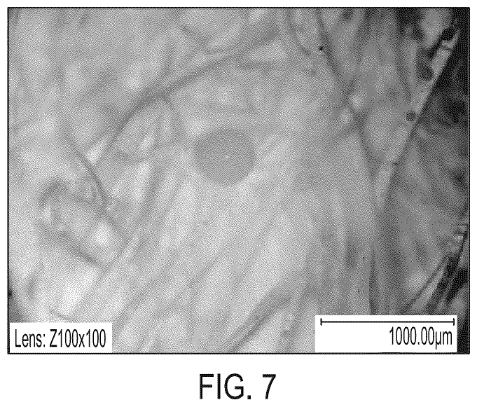

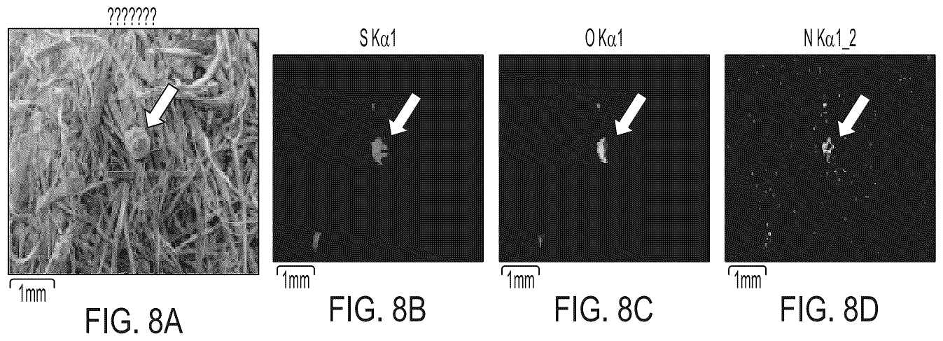

A syringe pump was used to inject 1 wt % H₂O₂ solution at a speed of 12.0 ml/hour to a 3.19 L/min gas stream comprising 200 ppm NO and 35 ppm SO₂ at 204° C. A catalytic filter medium sample as described above was placed downstream of the gas mixture, and the gas stream was flowed transverse through the cross section of the filter medium. The H₂O₂ concentration in the gas stream is about 630 ppm. The ratio of H₂O₂ concentration over SO₂ concentration in the gas stream is about 18. After 10 minutes of H₂O₂ injection, 10 ppm NH₃ was introduced into the gas stream for 5 minutes for ammonium bisulfate (ABS) salt particulate formation. After the experiment, the catalytic filter sample was taken out of the reactor and analyzed under Keyence VHX-6000 digital microscope. The optical image in FIG. 7 clearly showed a sphere particle was formed on the upstream surface of the catalytic filter sample. The chemical composition of the sphere particle was further analyzed by Hatachi TM3030 Plus Tabletop Scanning Electron Microscope (SEM). In FIG. 8A, a sphere particle was observed on the upstream surface of the catalytic filter sample under SEM. The elemental mapping (FIG. 8B-8D) results showed the particle was composed of sulfur, oxygen, and nitrogen, which is consistent with the chemical composition of ammonium bisulfate salt.

### Example 5: Injection of 0.6 wt % H₂O₂ Solution into a Gas Mixture of SO₂ and NH₃ (with Upstream Porous Protective Layer)

A catalytic filter medium was formed according to International Patent Publication No. WO 2019/099025 to Eves et al. The filter medium comprises a porous protective layer (made of ePTFE) and a porous catalytic layer having an upstream side felt batt and a downstream side porous catalytic film. The felt batt was formed of fleece formed from PTFE staple fiber. The filter medium was connected together by a plurality of perforations formed by a needle punching process, by a needling process, or both.

FIG. 1B represents an exemplary embodiment of a filter medium according to this example.

The porous catalytic film of the filter medium described above were prepared using the general dry blending methodology taught in U.S. Pat. No. 7,791,861 B₂ to Zhong et al. to form composite tapes that were then uniaxially expanded according to the teachings of U.S. Pat. No. 3,953,556 to Gore. The resulting porous fibrillated expanded PTFE (ePTFE) composite membranes included supported catalyst particles durably enmeshed and immobilized with the ePTFE node and fibril matrix.

Such filter medium in the form of filter bags is commercially available by W.L. Gore & Associates under the name GORE® DeNOx Catalytic Filter Bags.

A syringe pump was used to inject 0.6 wt % H₂O₂ solution at a speed of 12.0 ml/hour to a 0.45 L/min gas stream comprising of 100 ppm SO₂ and 800 ppm NH₃ at 150° C. The H₂O₂ concentration in the gas stream is about 2000 ppm. The ratio of H₂O₂ concentration over SO₂ concentration in the gas stream is about 20. The catalytic filter medium sample as described above was placed downstream the gas mixture, and the gas stream was flowing transverse through the cross section of the filter sample. After 30 minutes, H₂O₂ injection, NH₃ and SO₂ were turned off. The concentration of SO₂ before, and during the H₂O₂ injection was measured by a MKS MULTI-GAS™ 2030D Fourier-transform infrared spectroscopy (FTIR) analyzer (MKS Instruments, Andover, MA).

SO₂ conversion efficiency was calculated according to the SO₂ concentration before and during the H₂O₂ injection, SO₂ conversion efficiency (“SO₂ conversion”) (%)=((SO₂ without H₂O₂−SO₂ with H₂O₂)/SO₂ without H₂O₂)×100%.

The SO₂ concentration during the H₂O₂ solution injection is around 1 ppm. The SO₂ conversion efficiency is 99%.

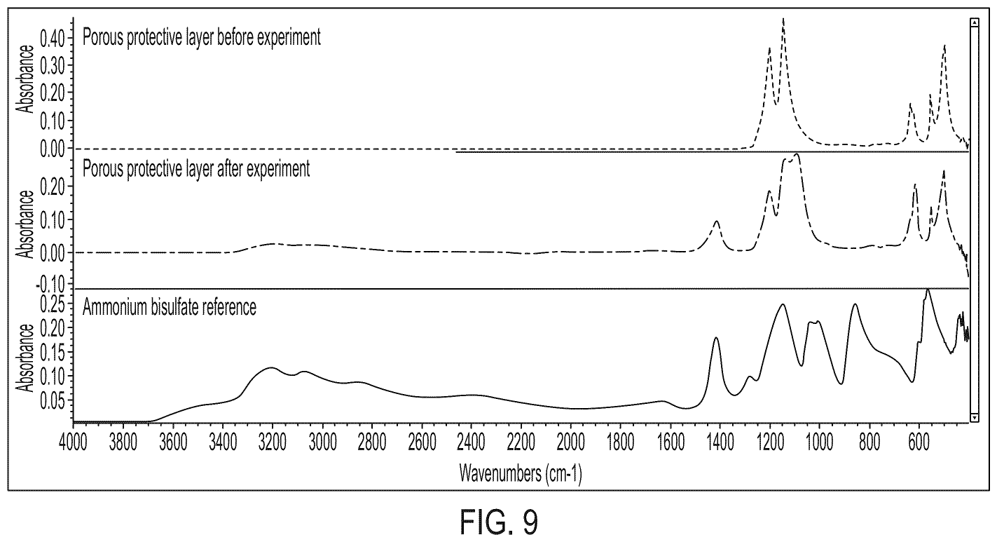

After the experiment, the catalytic filter sample was taken out of the reactor and the surface of the porous protective layer was analyzed by Nicolet™ iS50 FTIR spectrometer. FIG. 9 shows the FTIR spectrum collected on the surface of the porous protective layer after the experiment is consistent with the FTIR spectrum collected on ammonium bisulfate powder purchased from Sigma Aldrich. There were no ABS salt on the porous protective layer before the experiment. This example confirms that SO₂ was converted to ABS salt and collected by the porous protective layer of the catalytic filter sample when adding H₂O₂ solution to a gas stream containing of SO₂ and NH₃.

### Comparative Example 1: Injection of Deionized Water into a Gas Mixture of SO₂ and NH₃

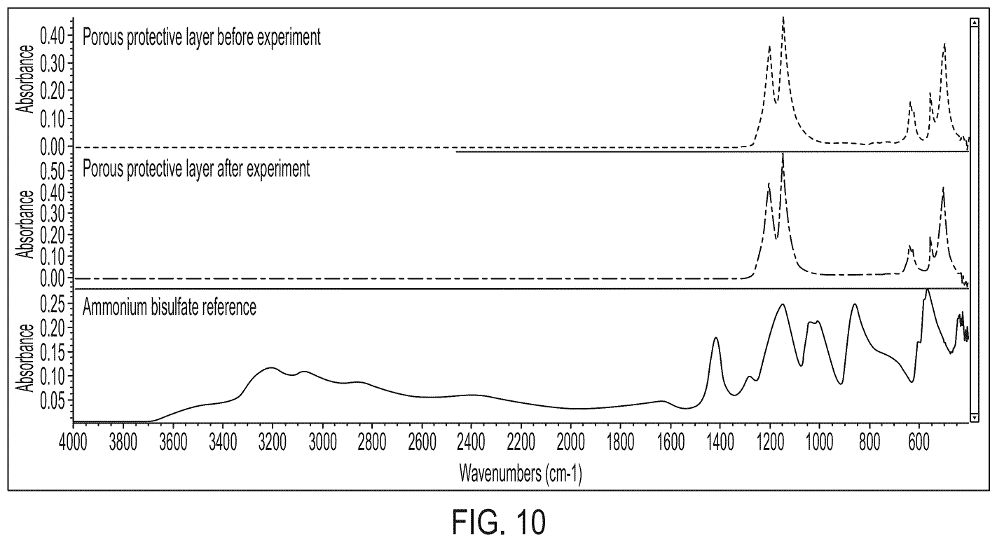

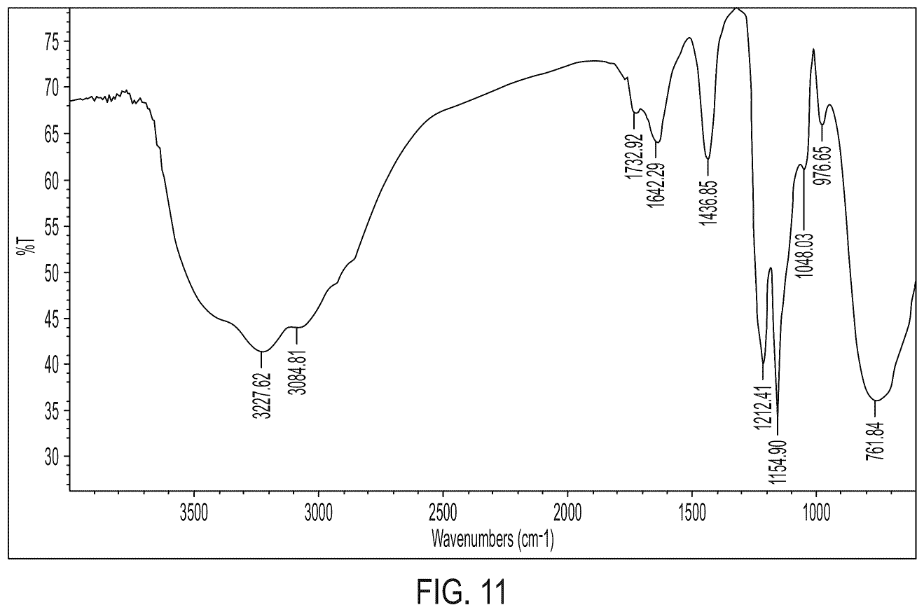

A syringe pump was used to inject deionized water at a speed of 12.0 ml/hour to a 0.45 L/min gas stream comprising 100 ppm SO₂ and 800 ppm NH₃ at 150° C. A catalytic filter medium sample described in Example 5 was placed downstream of the gas mixture, and the gas stream was flowing transverse through the cross section of the filter medium. After 30 minutes, deionized water injection, NH₃ and SO₂ were turned off. The surface of the porous protective layer was analyzed by Nicolet™ iS50 Fourier-transform infrared (FTIR) FTIR spectrometer. As shown in FIG. 10, no detectable ammonium bisulfate was formed on the surface of the porous protective layer after the experiment when H₂O₂ solution was replaced by deionized water.

### Example 6: Injection of 0.6 wt % H₂O₂ Solution into a Gas Stream Containing SO₂ and Dry Sorbent

A syringe pump was used to inject 0.6 wt % H₂O₂ solution at a speed of 12.0 ml/hour to a 0.45 L/min gas stream comprising of 100 ppm SO₂ at 230° C. The H₂O₂ concentration in the gas stream is about 2000 ppm. The ratio of H₂O₂ concentration over SO₂ concentration in the gas stream is about 20. The catalytic filter medium sample as described above in example 5 was placed downstream the gas mixture, and the gas stream was flowing transverse through the cross section of the filter sample. The surface of the porous protective layer was covered by a layer of cement clinker. The cement clinker contains 90-100 wt % Portland Cement and 0.3-3.0 wt % of calcium oxide. The experiment was conducted for 30 minutes. The elemental composition of the cement clinker on the porous protective layer was analyzed by Hatachi TM3030 Plus Tabletop Scanning Electron Microscope (SEM) before and after the experiment. The table below showed the sulfur wt % in the cement clinker increased from 1.2-1.7 wt % to 2.9-3.9 wt % before and after the test. The S/Ca ratio increased from 0.10-0.11 to 0.175-1.95. This result confirms that gas phase SO₂ was removed from the gas stream, captured by the dry sorbent, and collected by the porous protective layer of the catalytic filter sample when adding H₂O₂ solution to a gas stream containing of SO₂ and dry sorbent.

| | | Elemental composition | | | | | | | | |
|---|---|---|---|---|---|---|---|---|---|---|
| | | F, | C, | O, | Ca, | S, | Si, | Al, | Mg, | S/Ca |
| | | wt % | wt % | wt % | wt % | wt % | wt % | wt % | wt % | ratio |
| Before test | Test 1 | 47.9 | 19.5 | 16.9 | 11.9 | 1.2 | 1.2 | 0.5 | 0.3 | 0.10 |
| | Test 2 | 37.0 | 18.1 | 24.1 | 15.7 | 1.7 | 1.4 | 0.6 | 0.4 | 0.11 |
| After test | Test 1 | 26.2 | 13.1 | 32.8 | 20.0 | 3.9 | 1.8 | 0.7 | 0.5 | 0.195 |
| | Test 1 | 37.8 | 15.9 | 23.5 | 16.6 | 2.9 | 1.5 | 0.6 | 0.4 | 0.175 |

### Example 7: Injection of 27.5 wt % H₂O₂ Solution into a Gas Stream Containing SO₂, NH₃, and Dry Sorbent

An off-gas stream of 6000 Nm³/hour at 210° C. containing 270 mg/Nm³ SO₂, 23 g/Nm³ cement dust (dry sorbent) and 5-6 mg/Nm³ NH₃ was connected to a pilot scale baghouse system. The catalytic filter sample described in Example 5 in the form of filter bag was used with a total filtration area of 86.2 m².

The concentration of SO₂ before, and during the H₂O₂ injection was measured by an SDL Model 1080-UV analyzer. SO₂ conversion efficiency was calculated according to the SO₂ concentration before and during the H₂O₂ injection, SO₂ conversion efficiency (“SO₂ conversion”) (%)=((SO₂ without H₂O₂−SO₂ with H₂O₂)/SO₂ without H₂O₂)×100%.

When 12 L/hour water containing 27.5 wt % H₂O₂ solution is injected into the off-gas stream, about 45.6% of the SO₂ is removed. The calculated H₂O₂ concentration in the gas stream is about 550 ppm. The ratio of H₂O₂ concentration over SO₂ concentration in the gas stream is about 5.8. When 15 L/hour water containing 27.5 wt % H₂O₂ solution is injected into the off-gas stream, about 63.0% of the SO₂ is removed. The calculated H₂O₂ concentration in the gas stream is about 690 ppm. The ratio of H₂O₂ concentration over SO₂ concentration in the gas stream is about 7.3. After the experiment, the surface of the porous protective layer was analyzed by PerkinElmer Spectrum Two™ Fourier-transform infrared (FTIR) FTIR spectrometer. As shown in FIG. 11, ammonium bisulfate salt was detected on the surface of the porous protective layer.

Variations, modifications, and alterations to embodiments of the present disclosure described above will make themselves apparent to those skilled in the art. All such variations, modifications, alterations, and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A method comprising:
obtaining at least one filter medium;
wherein the at least one filter medium comprises at least one catalyst material;
flowing a flue gas stream transverse to a cross section of the at least one filter medium, such that the flue gas stream passes through the cross section of the at least one filter medium,
wherein the flue gas stream comprises sulfur dioxide (SO₂); and
increasing a SO₂ removal efficiency of the at least one filter medium,
wherein increasing the SO₂ removal efficiency of the at least one filter medium comprises:
introducing at least one oxidizing agent into the flue gas stream, so as to react at least some of the SO₂ with the at least one oxidizing agent to form sulfur trioxide (SO₃), sulfuric acid (H₂SO₄), or any combination thereof; and
introducing ammonia (NH₃) into the flue gas stream, so as to react at least some of the sulfur trioxide (SO₃), at least some of the sulfuric acid (H₂SO₄), or any combination thereof, with the ammonia (NH₃) and form at least one salt.

2. The method of claim 1, wherein the SO₂ removal efficiency of the at least one filter medium is increased from 0.1% to 99.9% relative to an initial SO₂ removal efficiency of the at least one filter medium.

3.-7. (canceled)

8. The method of claim 1, wherein the NH₃ is introduced into the flue gas stream in a concentration ranging from 0.0001% to 0.5% of the concentration of the flue gas stream.

9.-10. (canceled)

11. The method of claim 9, wherein the sufficient amount of the at least one oxidizing agent that is introduced into the flue gas stream is 5 ppm to 10000 ppm of the flue gas stream.

12. (canceled)

13. The method of claim 1, wherein a temperature of the flue gas stream ranges from 100° C. to 300° C. at least during the flowing of the flue gas stream transverse to a cross section of the at least one filter medium.

14.-17. (canceled)

18. The method of claim 1, further comprising removing the at least one salt from the at least one filter medium.

19. The method of claim 18, wherein the at least one filter medium comprises:
a porous protective layer; and
a porous catalytic layer,
wherein removing the at least one salt from the at least one filter medium comprises removing the at least one salt from the porous protective layer of the at least one filter medium.

20. (canceled)

21. The method of claim 1, wherein introducing the NH₃, into the flue gas stream is performed after introducing the at least one oxidizing agent into the flue gas stream.

22. The method of claim 1, wherein introducing the NH₃ into the flue gas stream is performed before introducing the at least one oxidizing agent into the flue gas stream, during the introducing of the at least one oxidizing agent into the flue gas stream, or any combination thereof.

23.-26. (canceled)

27. The method of claim 1, wherein
increasing the SO₂ removal efficiency of the at least one filter medium comprises:
introducing at least one oxidizing agent into the flue gas stream, so as to react at least 1 ppm of the SO₂ with the at least one oxidizing agent to form sulfur trioxide (SO₃), sulfuric acid (H₂SO₄), or any combination thereof; and
introducing ammonia (NH₃) into the flue gas stream, so as to react at least 1 ppm of the sulfur trioxide (SO₃), at least 1 ppm of the sulfuric acid (H₂SO₄), or any combination thereof, with the ammonia (NH₃) and form at least one salt.

28. The method of claim 1, wherein ammonia (NH₃) is introduced into the flue gas stream in a concentration ratio of NH₃ to NOx compounds of 7:200 to 9:5.

29. A system comprising:
at least one filter medium,
wherein the at least one filter medium comprises:
an upstream side;
a downstream side;
at least one catalyst material;
at least one filter bag,
wherein the at least one filter medium is disposed within the at least one filter bag; and
at least one filter bag housing,
wherein the at least one filter bag is disposed within the at least one filter bag housing;
wherein the at least one filter bag housing is configured to receive a flow of a flue gas stream transverse to a cross section of the at least one filter medium, such that the flue gas stream passes through the cross section of the at least one filter medium from the upstream side of the at least one filter medium to the downstream side of the at least one filter medium,
wherein the flue gas stream comprises sulfur dioxide (SO₂),
wherein the system is configured to increase a SOx removal efficiency of the at least one filter medium upon:
introduction of at least one oxidizing agent into the flue gas stream; and
introduction of ammonia (NH₃) into the flue gas stream.

30. The system of claim 29, wherein the system is configured to further increase a SOx removal efficiency of the at least one filter medium upon introduction of at least one dry sorbent into the flue gas stream.

31.-32. (canceled)
